(19) United States
(12) Patent Application Publication
(10) Pub. No.: US 2013/0212440 A1
(43) Pub. Date: Aug. 15, 2013

(54) SYSTEM AND METHOD FOR VIRTUAL SYSTEM MANAGEMENT

(71) Applicants: Li-Raz Rom, Netanya (IL); Doron Girmonski, Ra'anana (IL); Yaron Shmueli, Kfar-Saba (IL); Meir Bechor, Kiryat Ono (IL); Dan Eidelman, Holon (IL)

(72) Inventors: Li-Raz Rom, Netanya (IL); Doron Girmonski, Ra'anana (IL); Yaron Shmueli, Kfar-Saba (IL); Meir Bechor, Kiryat Ono (IL); Dan Eidelman, Holon (IL)

(21) Appl. No.: 13/371,593

(22) Filed: Feb. 13, 2012

(51) Int. Cl. G06F 11/30

(52) U.S. Cl. 714/47.1; 714/E11.179

(57) ABSTRACT

A system and method for virtual system management. A set of data received from a plurality of data sensors may be analyzed, each sensor monitoring performance at a different system component. Sub-optimal performance may be identified associated with at least one component based on data analyzed for that component's sensor. A cause of the sub-optimal performance may be determined using predefined relationships between different value combinations including scores for the set of received data and a plurality of causes. An indication of the determined cause may be sent, for example, to a management unit. A solution to improve the sub-optimal performance may be determined using predefined relationships between the plurality of causes of problems and a plurality of solutions to correct the problems.

### BACKGROUND OF THE INVENTION

Virtual System Management (VSM) may optimize the use of information technology (IT) resources in a network or system. In addition, VSM may integrate multiple operating systems (OSs) or devices by managing their shared resources. Users may manage the allocation of resources remotely at management terminals.

VSM may also manage or mitigate the damage resulting from system failure by distributing resources to minimize the risk of such failure and streamlining the process of disaster recovery in the event of system compromise. However, although VSM may detect failure and manage recovery after the failure occurs, VSM may not be able to anticipate or prevent such failure.

### SUMMARY OF THE INVENTION

In an embodiment of the invention, for example, for virtual system management, a set of data received from a plurality of data sensors may be analyzed. Each sensor may monitor performance at a different system component. Sub-optimal performance may be identified associated with at least one component based on data analyzed for that component's sensor. A cause of the sub-optimal performance may be determined using predefined relationships between different value combinations including scores for the set of received data and a plurality of causes. An indication of the determined cause may be sent, for example, to a management unit. A solution to improve the sub-optimal performance may be determined using predefined relationships between the plurality of causes of problems and a plurality of solutions to correct the problems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system for virtual system management (VSM) in accordance with an embodiment of the invention;

FIG. 2 is a graph of statistical data collected at VSM sensors over time in accordance with an embodiment of the invention;

FIG. 3 is a flowchart of a method for detecting patterns in device behavior in a VSM system in accordance with an embodiment of the invention;

FIG. 4 schematically illustrates a VSM system in accordance with an embodiment of the invention;

FIG. 5 is a histogram representing the image luminance of a frame in accordance with an embodiment of the invention;

FIG. 6 schematically illustrates data structures in a VSM system in accordance with an embodiment of the invention;

FIG. 7 schematically illustrates throughput insights generated by the resource manager engine of FIG. 6, in accordance with an embodiment of the invention;

FIG. 8 schematically illustrates quality of experience insights generated by the resource manager engine of FIG. 6, in accordance with an embodiment of the invention;

FIG. 9 schematically illustrates abnormal behavior alarms generated by the resource manager engine of FIG. 6, in accordance with an embodiment of the invention;

FIG. 10 schematically illustrates a workflow for monitoring storage throughput in accordance with an embodiment of the invention;

FIG. 11 schematically illustrates a workflow for checking internal server throughput in accordance with an embodiment of the invention;

FIGS. 12A and 12B schematically illustrate a workflow for checking if a network issue causes a decrease in storage throughput in accordance with an embodiment of the invention;

FIGS. 13A and 13B schematically illustrate a workflow for checking if a decrease in storage throughput is caused by a network interface card in accordance with an embodiment of the invention;

FIG. 14 schematically illustrates a workflow for checking if a cause for a decrease in storage throughput is the storage itself, in accordance with an embodiment of the invention;

FIGS. 15A and 15B schematically illustrate a workflow for checking for connection availability in accordance with an embodiment of the invention;

FIG. 16 schematically illustrates a workflow for checking the cause of a decrease in storage throughput if a read availability test fails, in accordance with an embodiment of the invention;

FIG. 17 schematically illustrates a workflow for checking the cause of a decrease in storage throughput if a read availability test fails, in accordance with an embodiment of the invention;

FIG. 18 schematically illustrates a workflow for checking if a rebuild operation is a cause of a decrease in the storage throughput, in accordance with an embodiment of the invention;

FIG. 19 schematically illustrates a workflow for checking if a decrease in storage throughput is caused by a storage disk, in accordance with an embodiment of the invention;

FIG. 20 schematically illustrates a workflow for checking if a decrease in storage throughput is caused by a controller, in accordance with an embodiment of the invention;

FIG. 21 schematically illustrates a workflow for detecting a cause of a decrease in a quality of experience measurement in accordance with an embodiment of the invention;

FIGS. 22A and 22B schematically illustrate a workflow for detecting if a cause of a decrease in a quality of experience measurement is a network component in accordance with an embodiment of the invention;

FIG. 23 schematically illustrates a workflow for detecting if a cause of a decrease in a quality of experience measurement is a client component in accordance with an embodiment of the invention;

FIG. 24 schematically illustrates a system for transferring of data from a source device to an output device in accordance with an embodiment of the invention;

FIG. 25 schematically illustrates a workflow for checking if a decrease in a quality of experience measurement is caused by low video quality, in accordance with an embodiment of the invention;

FIGS. 26, 27 and 28 each include an image from a separate video stream and graphs of an average quantization value of the video streams, in accordance with an embodiment of the invention;

FIGS. 29A and 29B schematically illustrate a workflow for using abnormal behavior alarms in accordance with an embodiment of the invention;

FIG. 30 schematically illustrates a system of data structures used to detect patterns of behavior over time in accordance with an embodiment of the invention; and

FIGS. 31A and 31B schematically illustrate a workflow for determining availability insights in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may include a VSM system to monitor the performance of system components, such as recording components in a surveillance system, predict future component failure based on performance and dynamically shift resource allocation to other components or reconfigure components to avoid or mitigate such future failure. In general, a system may be a collection of computing and data processing components including for example sensors, cameras, etc., connected by for example one or more networks or data channels. A VSM system may include a network of a plurality of sensors distributed throughout the system to measure performance at a plurality of respective components. The sensors may be external devices attached to the components or may be internal or integral parts of the components, for example, that serve other component functions. In one example, a camera may both record video (e.g., a video stream, a series of still images) and monitor its own recording performance since the recorded images and audio may be used to detect such performance. Similarly, an information channel (e.g., a network component, router, etc.) may inherently calculate its own throughput, or, a separate sensor may be used.

A VSM system may include logic to, based on the readings of the network of sensors, determine current or potential future system failure at each component and diagnose the root cause of such failure or potential failure. In a demonstrative example, the VSM system may include a plurality of sensors each measuring packet loss (e.g., throughput) over a different channel (e.g., network link). If only one of the sensors detects a greater than threshold measure of packet loss, VSM logic may determine the cause of the packet loss to be the specific components supporting the packet loss channel. However, if all sensors detect a greater than threshold measure of packet loss over all the channels, VSM logic may determine the cause of the packet loss to be a component that affects all the channels, such as, a network interface controller (NIC). These predetermined problem-cause relationships or rules may be stored in a VSM database. In addition to packet loss, the VSM system may measure internal component performance (e.g., processor and memory usage), internal configuration performance (e.g., drop in throughput due to configuration settings, such as, frames dropped for exceeding maximum frame size), teaming configuration performance (e.g., performance including load balancing of multiple components, such as, multiple NICs teamed together to operate as one) and quality of experience (QoE) (e.g., user viewing experience).

VSM logic may include a performance function to weigh the effect of the data collected by each sensor on the overall system performance. The performance function may be, for example, a key performance indicator (KPI) value, KPIᵥₐₗᵤₑ=F(w₁*S₁+ . . . +wₙ*Sₙ), where Si (i=1, . . . , n) is a score associated with the ith sensor reading and wi is a weight associated with that score. Other functions may be used. Using statistical analysis to monitor the value of the function over time, the VSM system may determine any shift in an individual sensor's performance. A shift beyond a predetermined threshold may trigger an alert for the potential failure of the component monitored by that sensor.

Whereas other systems may simply detect poor system performance (the result of system errors), the VSM system operating according to embodiments of the invention may determine the root cause of such poor performance and identify the specific responsible components. The root cause analysis may be sent to a system administrator or automated analysis engine, for example, as a summary or report including performance statistics for each component (or each sensor). Statistics may include the overall performance function value, KPIvalue, the contribution or score of each sensor, Si, and/or representative or summary values thereof such as their maximum, minimum and/or average values. These statistics may be reported with a key associating each score with a percentage, absolute value range, level or category of success or failure, such as, excellent, good, potential for problem and failure, for example, for a reviewer to more easily understand the statistics.

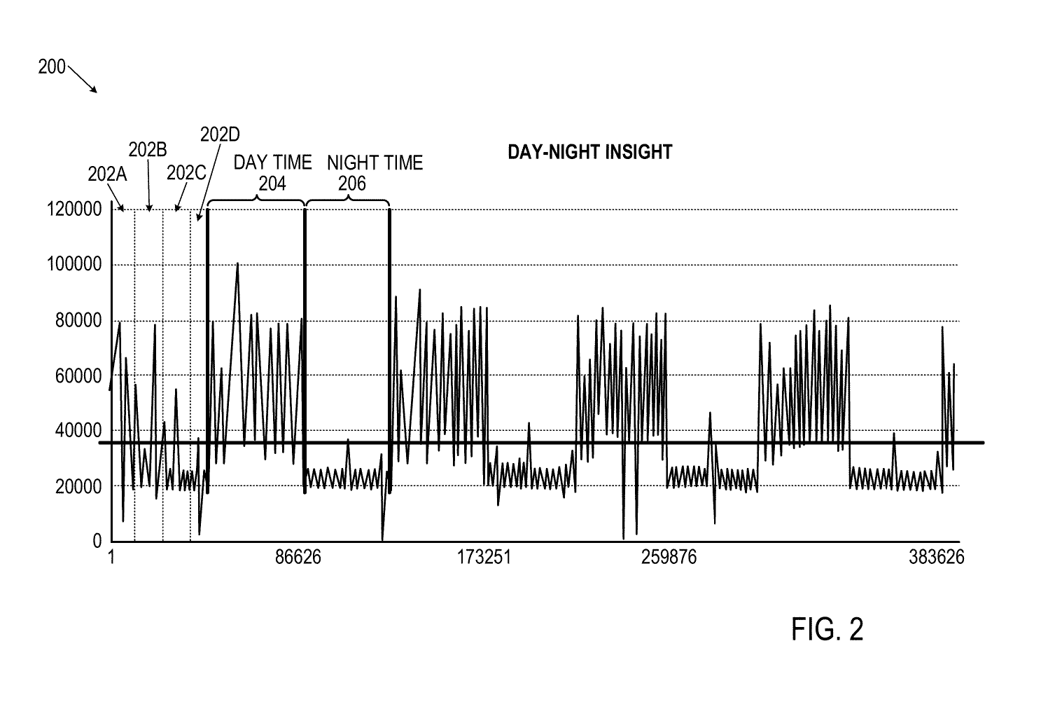

The VSM system may also monitor these statistics as patterns changing over time (e.g., using graph 200 of FIG. 2). Monitoring pattern of performance statistics over time may allow reviewers to more accurately detect causes of failure and thereby determine solutions to prevent such failure. In one example, if failure occurs at a particular time, for example, periodically each day due to periodic effects, such as over-saturating a camera by direct sunlight at that time or an audio-recorder saturated by noisy rush-hour traffic, the problem may be fixed by a periodic automatic and/or manual solution, such as, dimming or rotating the camera or filtering the audio recorder at those times. In another example, monitoring performance patterns may reveal an underlying cause of failure to be triggered by a sequence of otherwise innocuous events, such as, linking the failure of a first component with an event at a second related component, such as, each time the first component fails, a temperature sensor at the second component registers over-heating. Thus, to avoid failure at the first component, the second component may be periodically shut down or cooled with a fan to prevent the root cause of over-heating. The determined solution (e.g., cooling) may be automatically executed by altering the behavior of the component associated with the sub-optimal performance itself (e.g., shutting down the second component) or by automatically executing another device (turning on a fan that cools the second component). Other root causes and solution relationships may exist.

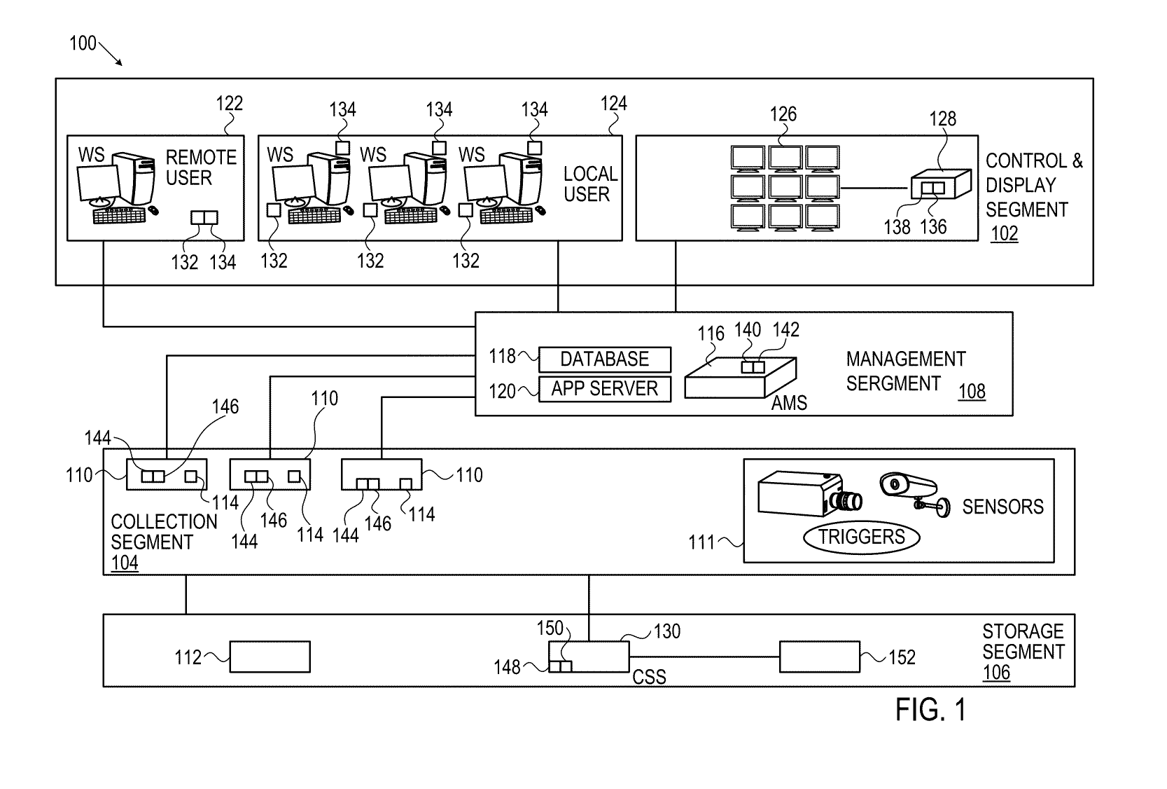

Reference is made to FIG. 1, which schematically illustrates a system 100 for virtual system management (VSM) in accordance with an embodiment of the invention. In the example of FIG. 1, system 100 monitors the performance of system components such as recorders, such as, video and audio recorders, although system 100 may monitor any other components, such as, input devices, output devices, displays, processors, memories, etc.

System 100 may include a control and display segment 102, a collection segment 104, a storage segment 106 and a management segment 108. Each system segment 102, 104, 106, and 108 may include a group of devices that are operably connected, have interrelated functionality, are provided by the same vendor, or that serve a similar function, such as, interfacing with users, recording, storing, and managing, respectively.

Collection segment 104 may include edge devices 111 to collect data, such as, video and audio information, and recorder 110 to record the collected data. Edge devices 111 may include, for example, Internet protocol (IP) cameras, digital or analog cameras, camcorders, screen capture devices, motion sensors, light sensors, or any device detecting light or sound, encoders, transistor-transistor logic (ttl) devices, etc. Edge devices 111 (e.g., devices on the “edge” or outside of system 100) may communicating with system 100, but may operate independently of (not directly controlled by) system 100 or management segment 108. Recorders 110 may include a server that records, organizes and/or stores the collected data stream input from edge devices 111. Recorders 110 may include, for example, smart video recorders (SVRs). Edge devices 111 and recorders 110 may be part of the same or separate devices.

Recorders 110 may have several functions, which may include, for example:

Recording video and/or audio from edge devices 111, e.g., including IP based devices and analog or digital cameras.

Performing analytics on the incoming video stream(s).

Sending video(s) to clients.

Performing additional processes or analytics, such as, content analysis, motion detection, camera tampering, etc.

Recorders 110 may be connected to storage segment 106 that includes a central storage system (CSS) 130 and storage units 112 and 152. The collected data may be stored in storage units 112. Storage units 112 may include a memory or storage device, such as, a redundant array of independent disks (RAID). CSS 130 may operate as a back-up server to manage, index and transfer duplicate copies of the collected data to be stored in storage units 152.

Control segment 102 may provide an interface for end users to interact with system 100 and operate management system 108. Control segment 102 may display media recorded by recorders 110, provide performance statistics to users, e.g., in real-time, and enable users to control recorder 110 movements, settings, recording times, etc., for example, to fix problems and improve resource allocation. Control segment 102 may broadcast the management interface via displays at end user devices, such as, a local user device 122, a remote user device 124 and/or a network of user devices 126, e.g., coordinated and controlled via an analog output server (AOS) 128.

Management segment 108 may connect collection segment 104 with control segment 102 to provide users with the sensed data and logic to monitor and control the performance of system 100 components. Management segment 108 may receive a set of data from a network of a plurality of sensors 114, each monitoring performance at a different component in system 100 such as recorders 110, edge devices 111, storage unit 112, user devices 122, 124 or 126, recording server 130 processor 148 or memory 150, etc. Sensors 114 may include software modules (e.g., running processes or programs) and/or hardware modules (e.g., incident counters or meters registering processes or programs) that probe operations and data of system 100 components to detect and measure performance parameters. A software process acting as sensor 114 may be executed at recorders 110, edge devices 111 or a central server 116. Sensors 114 may measure data at system components, such as, packet loss, jitter, bit rate, frame rate, a simple network management protocol (SNMP) entry in storage unit 112, etc. Sensor 114 data may be analyzed by an application management server (AMS) 116. AMS 116 may include a management application server 118 and a database 120 to provide logic and memory for analyzing sensor 114 data. In some embodiments, AMS 116 may identify sub-optimal performance, or performance lower than an acceptable threshold, associated with at least one recorder 110 or other system component based on data analyzed for that recorder's sensor 114. Such analysis may, in some cases, be used to detect current, past or possible future problems, determine the cause(s) of such problems and change recorder 110 behavior, configuration settings or availability, in order to correct those problems. In some embodiments, database 118 may store patterns, rules, or predefined relationships between different value combinations of the sensed data (e.g., one or more different data values sensed from at least one or more different sensors 114) and a plurality of root causes (e.g., each defining a component or process responsible for sub-optimal function). AMS 116 may use those relationships or rules to determine, based on the sensed data, the root cause of the sub-optimal performance detected at recorder 110. Furthermore, database 118 may store predefined relationships between root causes and solutions to determine, based on the root cause, a solution to improve the sub-optimal performance. AMS 116 may input a root cause (or the original sensed data) and, based on the relationships or rules in database 118, output a solution. There may be a one-to-one, many-to-one or one-to-many correlation between sensed data value combinations and root causes and/or between root causes and solutions. These relationships may be stored in a table or list in database 118. AMS 116 may send or transmit to users or devices an indication of the determined root cause(s) or solution(s) via control segment 102.

Recorders 110, AMS 116, user devices 122, 124 or 126, AOS 128, recording server 130, may each include one or more controller(s) or processor(s) 144, 140, 132, 136 and 148, respectively, for executing operations and one or more memory unit(s) 146, 142, 134, 138 and 150, respectively, for storing data and/or instructions (e.g., software) executable by a processor. Processor(s) 144, 140, 132, 136 and 148 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 146, 142, 134, 138 and 150 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

System components may be affected by their own behavior or malfunctions, and in addition by the functioning or malfunctioning of other components. For example, recorder 110 performance may be affected by various components in system 100, some with behavior linked or correlated with recorder 110 behavior (e.g., recorder 110 processor 144 and memory 146) and other components with behavior that functions independently of recorder 110 behavior (e.g., network servers and storage such as storage unit 112). Sensors 114 may monitor components, not only with correlated behavior, but also components with non-correlated behavior. Sensors 114 may monitor performance parameters, such as, packet loss, jitter, bit rate, frame rate, SNMP entries, etc., to find correlations between sensors' 114 behavior, patterns of sensor 114 behavior over time, and a step analysis in case a problem is detected. AMS 116 may aggregate performance data associated with all recorders 110 (and other system 100 components) and performance parameters, both correlated and non-correlated to sensors' 114 behavior, to provide a better analysis of, not only the micro state of an individual recorder, but also the macro state of the entire system 100, for example a network of recorders 110. Other types of systems with other components may be monitored or analyzed according to embodiments of the present invention.

In contrast to other systems, which only identify the result or symptoms of a problem, such as, a decrease in throughput or bad video quality, AMS 116 may detect and identify the cause of the problem. By aggregating data detected at all sensors 114 and combining them using a performance function, AMS 116 may weigh each sensor 114 to determine the individual effect or contribution of the data collected by the sensor on the entire system 100. The performance function may be, for example: KPIᵥₐₗᵤₑ=F(w₁*S₁+ . . . +wₙ*Sₙ), although other functions may be used. Example scores, Si (i=1-10), are defined below according to tables 1-10 (other scores may also be used). AMS 116 may use tables 1-10 to map performance parameters (left column in the tables) that are sensed at sensors 114 or derived from the sensed data to scores (right column in the tables). Once the scores are defined, AMS 116 may calculate the value of the performance function based thereon and, looking up the function value in another relationship table, may identify the associated cause(s) of the problem.

In some embodiments, one or more processors are analyzed as system components, for example, processor(s) 132, 136, 144, and/or 148. For example, processor score (S1) may measure processor usage, for example, as a percentage of the processor or central processing unit (CPU) usage. Recording and packet collection may depend on the performance of processor 148 of recording server 130. As the processor works harder and its usage increases, the time slots for input/output (I/O) operations may decrease. While a certain set of scores or ratings is shown in Table 1 and other tables herein, other scores or rating methods may be used.

TABLE 1
CPU Score (S1)

| Average CPU | Score (S1) |
|---|---|
| CPU < 50% | Excellent |
| CPU < 60% | Very good |
| CPU < 75% | Good |
| CPU > 75% | Potential for a problem |

Each score category or level, such as, excellent, good, potential for problem and failure, may represent a numerical value or range, for example, which may be combined with other numeric scores in the performance function.

In some embodiments, one or more memory or storage units are analyzed as system components. For example, Virtual Memory (VM) may measure memory and/or virtual memory usage. Recorder 110 performance may dependent on memory usage. As recorder 110 consumes a high amount of memory, performance typically decreases.

TABLE 2
Virtual Memory Score (S2)

| Average VM | Score (S2) |
|---|---|
| VM < 2.2 GB | Excellent |
| VM < 2.5 GB | Very good |
| VM < 2.9 GB | Good |
| VM > 3 GB | Potential for a problem |

Teaming score (termed in one embodiment S3) may indicate whether or not multiple components are teamed (e.g., integrated to work together as one such component). For example, two NICs may be teamed together. Teamed components may work together using load balancing, for example, distributing the workload for one component across the multiple duplicate components. For example, the two NICs, each operating at speed of 1 gigabyte (GB), may have a total bandwidth of 2 GB. Teamed components may also be used for fault tolerance, for example, in which when one duplicate component fails, another may take over or resume the failed task. If recorder 110 is configured with teaming functionality and there is a disruption or break in this functionality (teaming functionality is off), system performance may decrease and the teaming score may likewise decrease to reflect the teaming malfunction.

TABLE 3
Teaming Functionally (S3)

| Teaming Functionally | Score (S3) |
|---|---|
| Operational | Excellent |
| Not Operational | Potential for a problem |

Internal configuration score (S4) may indicate whether or not recorder 110 is internally configured, for example, to ensure that the recorded frame size does not exceed a maximum frame size. A disruption in this functionality may decrease performance.

TABLE 4
Internal configuration (S4)

| Internal configuration Functionally | Score (S4) |
|---|---|
| Operational | Excellent |
| Not Operational | Potential for a problem |

In some embodiments, one or more network components are analyzed as system components. For example, packet loss (S5) may measures the number of packet losses at the receiver-side (e.g., at recorder 110 or edge device 111) and may define thresholds for network quality according to average packet loss per period of time (e.g., per second). Since the packaging of frames into packets may be different and unique for each edge device 111 vendor or protocol, the packet loss score calculation may be based on a percentage loss. 100% may represent the total number of packets per period of time.

TABLE 5
Packet Loss (S5)

| Packet loss/Sec | Score (S5) |
|---|---|
| PL/S < 0.005% | Excellent |
| 0.005% < PL/S < 0.01% | Very good |
| 0.01% < PL/S < 0.05% | Good |
| PL/S > 0.5% | Potential for a problem |

Change in configuration score (S6) may measure a change to one or more configuration parameters or settings at, for example, edge device 111 and/or recorder 110. When the configuration at edge device 111 is changed by devices other than recorder 110, the calculated retention or event over flow in the retention may be decreased, thereby degrading performance.

TABLE 6
Frame drops (S6)

| Frame drops due to wrong configuration | Score (S6) |
|---|---|
| Not Changed | Excellent |
| Changed | Potential for a problem |

Network errors score (S7) may measure the performance of a network interface card. The network speed may change and cause a processing bottleneck. High utilization may cause overload on the server. When the card buffers are running low, the card may discard packets or the packet may arrive corrupted.

TABLE 7
Network Errors (S7)

| NIC errors | Score (S7) |
|---|---|
| Change in speed | 50 |
| High Utilization | Utilization |
| Discard packets > 1% | 10 * percent |
| Error packet > 1% | 10 * percent |

Storage connection availability score (S8) may measure the connection between storage unit 112 and recorder 110 and/or edge device 111. The connection to storage unit 112 may be direct, e.g., using a direct attached storage (DAS), or indirect, e.g., using an intermediate storage area network (SAN) or network attached storage (NAS).

TABLE 8
Storage availability (S8)

| Storage availability | Score (S8) |
|---|---|
| Available | Excellent |
| Not available | Potential for a problem |

Storage read availability score (S9) may measure the amount (percentage) of storage unit 112 that is readable. For example, although storage unit 112 may be available, it's functionally maybe malformed. Therefore an accurate measure of storage unit 112 performance may depend on a percent of damaged disks (e.g., depending on the RAID type).

TABLE 9
Storage Availability (S9)

| Read available | Score (S9) |
|---|---|
| No damaged disks | Excellent |
| Damaged disks > 60% | Potential for a problem |

Storage error score (S9) may measure internal storage unit 112 errors. Storage unit 112 may have internal errors that may cause degraded performance. For example when internal errors are detected in storage unit 112, a rebuild process may be used to replace the damaged data. When a high percentage of storage unit 112 is being rebuilt, the total bandwidth for writing may be small. Furthermore, if a substantially long or above threshold time is used to rebuild storage unit 112, the total bandwidth for writing may be small. RAID storage units 112 may include “predicted disks,” for example, disks predicted to be damaged using a long rebuild time for writing/reading to/from storage units 112. If there is a high percent of predicted disks in storage units 112, the total bandwidth for writing may be small and performance may be degraded. Performance may be further degraded, for example, when a controller in storage unit 112 decreases the total bandwidth for writing, for example, due to problems, such as, low battery power, problems with an NIC, etc.

TABLE 10
Storage Errors (S10)

| Storage errors | Score (S10) |
|---|---|
| Rebuild on 60% disks | 10 |
| Long rebuild Time | 10 |
| % predicted disks | percent |
| Error in controller | 10 |

Performance scores (e.g., S1-S10) may be combined and analyzed, e.g., by AMS 116, to generate performance statistics, for example, as shown in table 11.

TABLE 11
Performance Analysis

| | | | | | | Poten- |
|---|---|---|---|---|---|---|
| | Sub score | Re- | Score | Weight | | tial |
| Measure | feature | sult | mapping | [%] | Total | problem |
| CPU | Recorder | 35 | 35 | 5% | 1.75 | X |
| | Internal | | | | | |
| Virtual | Recorder | 2.7 | 70 | 5% | 35 | X |
| Memory | Internal | | | | | |
| Wrong | Recorder | 5% | 85 | 12% | 10.02 | V |
| Configuration | Internal | | | | | |
| Teaming | Recorder | 0 | 0 | 11% | 0 | X |
| | Internal | | | | | |
| Packet loss | Network | 0.3% | 75 | 11% | 8.25 | V |
| Change in | Network | 0 | 0 | 11% | 0 | X |
| configuration | | | | | | |
| NIC errors | Network | 70 | 70 | 11% | 7.7 | V |
| Storage | Storage | 0 | 0 | 11% | 6.00 | X |
| Availability | | | | | | |
| Storage read | Storage | 0 | 0 | 11% | 0 | X |
| availability | | | | | | |
| Storage errors | Storage | 25 | 25 | 11% | 2.75 | V |
| Total | | | | | 71.22 | V |
| Throughput | | | | | | |
| score | | | | | | |

For each different score or performance factor (each different row in Table 11), the raw performance score (e.g., column 3) may be mapped to scaled scores (e.g., column 4) and/or weighted (e.g., with weights listed column 5). Once mapped and/or weighted, the total scores for each component (e.g., column 6) may be combined in the performance function to generate a total throughput score for the overall system (e.g., column 6, bottom row). The total scores (e.g., for each factor and the overall system) may be compared to one or more thresholds or ranges to determine the level or category of success or failure. In the example shown in Table 11, there are two performance categories, potentially problematic video quality (V) and not problematic video quality (X)) defined for each factor and for the overall system (although any number of performance categories or values may be used). Other methods of combining scores and analyzing scores may be used.

Based on an analysis of data collected at sensors 114, AMS 116 may compute for example the following statistics or scores for video management; other statistics may be used:

Measurement of recorded throughput;

Measurement of quality of experience (QoE); and

Patterns of change in the recorded throughput or quality of experience, for example, which correlates with related sensors 114.

The recorded throughput may be affected by several performance parameters, such as, packet loss, jitter, bit rate, frame rate, SNMP entries, etc., defining the operation of system 100 components, such as:

Edge device

Storage

Recorder internal

Collecting network

In some cases the recorded throughput may change due to standard operation (e.g., edge device 111 may behave differently during the day and during the night), while in other cases the recorded throughput may change due to problems (e.g., intra frames exceed a maximum size and recorder 110 drops them, storage unit 112 includes damaged disks that do not perform well, collection segment 104 drops packets, etc.). AMS 116 may use information defining device parameters to differentiate standard operations from problematic operations. By collecting sensor 114 data informative to a video recording system 100, AMS 116 may process the data to generate insights and estimate the causes of problems. In some embodiments, a decrease in throughput may be caused by a combination of a plurality of correlated factors and/or non-correlated factors, for example, that occur at the same time. While in some embodiments a system such as AMS 116 may carry out methods according to the present invention, in other embodiments other systems may perform such methods.

Pattern detection may be used to more accurately detect and determine the causes of periodic or repeated abnormal behavior. In one example, increasing motion in a recorded scene may cause the compressed frame size to increase (and vice versa) since greater motion is harder to compress. Thus, in an office environment with less motion over the weekends, every weekend the compressed frame size may decrease thus decreasing recorded throughput, e.g., by approximately 20%. To determine patterns in component operations, performance parameters collected at sensors 114 may be monitored over time, for example, as shown in FIG. 2.

Reference is made to FIG. 2, which is a graph 200 of statistical data collected at VSM sensors over time in accordance with an embodiment of the invention. Graph 200 measures statistical data values (y-axis) vs. time (x-axis). The statistical data values may be collected at one or more sensors (e.g., sensors 114 in FIG. 1) and may monitor pre-analyzed performance parameters of system components (e.g., system 100 components, such as, recorders 110, storage unit 112, recording server 130, etc.), such as, packet loss, jitter, bit rate, frame rate, SNMP entries, etc., or post-analyzed performance statistics, such as, throughput, QoE, etc. In some embodiments, performance may be detected based on the data supplied by the component itself, (e.g., the focus of a camera, an error rate in the data that comes from the device or based on known setup parameters of the device), and a separate external or additional sensor is not required. In such embodiment, the component in the device that provides such data (or the device itself) may be considered to be the sensor.

To analyze component behavior, all the statistical data samples collected at the component's sensor (e.g., the sensor associated with the component) may be divided into bins 202 (e.g., bins 202(a)-(d)) of data spanning equal (or non-equal) time lengths, e.g., one hour or one day.

Patterns may be detected by analyzing and comparing repeated behavior in the statistical data of bins 202. For example, the statistical data in each bin 202 may be averaged and the standard deviation may be calculated. For example, the average size of each bin Ni, i=1−n, may be calculated to be (as with other formulas discussed herein, other formulas may be used):

$$\overline{x} = \frac{1}{n} {\sum }_{i = 1}^{n} {a}_{i} = \frac{{a}_{1} + {a}_{2} + … + {a}_{n}}{n}$$

The standard deviation for each bin 202 Ni may be calculated, for example, as:

$$s = \sqrt{\frac{1}{N - 1} {\sum }_{i = 1}^{N} {( {x}_{i} - \overline{x} )}^{2}}$$

Bins 202 with similar standard deviations may be considered similar and, when such similar bins are separated by fixed time intervals, their behavior may be considered to be part of a periodic pattern.

To detect patterns, bins 202 may be compared in different modes or groupings, such as:

Group mode in which a plurality of statistical data bins 202 are compared in bundles or groups.

Single time slot mode in which bins 202 are compared individually to one another.

In group mode, adjacent time bins 202 may be averaged and may be compared to the next set of adjacent time bins 202. In this way, patterns that behave in a periodic or wave-like manner may be detected. For example, such patterns may fluctuate based on time changes from day to night (e.g., as shown in the example of FIG. 2) or from weekend days to non-weekend days. If the statistical data differs by statistical tests, such as, T-tests, it may be determined if such trends exists across all similar groups of bin 202.

If so, a pattern may be detected; otherwise, a pattern may not be detected. In some embodiments, if no pattern is detected with one type of bin 202 grouping (e.g., weekend/weekday), another bin 202 grouping may be investigated (e.g., night/day). The groupings may be iteratively increased (or decreased) to include more and more (or less and less) bins 202 per group, for example, until a pattern is found or a predetermined maximum (or minimum) number of bins 202 are grouped.

In the example shown in FIG. 2, each bin 202 has a length of one hour. Statistical data for a group of day-time bins 204, e.g., spanning times from 07:00 until 17:00, may be compared to statistical data for another group of night-time bins 206, e.g., spanning times from 17:00 until 06:00. If the comparison shows a difference from day to night, e.g., greater than a predetermined threshold such as a 20% decrease in throughput, the comparison may be repeated for all (or some) other day-time and night-time bins 202 to check if this behavior recurs as part of a pattern.

In single time slot mode, each bin 202 may be compared to other bins 202 of each time slot to detect repetitive abnormal behavior. If repetitive abnormal behavior is detected, the detected behavior may reveal that the cause of such dysfunction occurs periodically at the bins' periodic times. For example, each Monday morning a garbage truck may pass a recorder and saturate its audio levels causing a peak in bit rate, which increases throughput at the recorder by approximately 40%. By finding this individual time slot pattern, a user or administrator may be informed of those periodic times when problems occur and as to the nature of the problem (e.g., sound saturation). The user may observe events at the predicted future time and, upon noticing the cause of the problem (e.g., the loud passing of the garbage truck), may fix the problem (e.g., by angling the recorder away from a street or filtering/decreasing the input volume at those times). Alternatively or additionally, the recorder may automatically self-correct, without user intervention, e.g., preemptively adjusting input levels at the recorder or recorder server to compensate for the predicted future sound saturation.

In single time slot mode, individual matching bins 202 may be detected using cluster analysis, such as, distribution based clustering, in which bins 202 with similar statistical distributions are clustered. A cluster may include bins 202 having approximately the same distribution or distributions that most closely match the same one of a plurality of distribution models. To check if each cluster of matching bins 202 forms a pattern, the intervals between each pair of matching bins 202 in the cluster may be measured. If the intervals between clustered bins 202 is approximately (or exactly) constant or fixed, a pattern may be detected at that fixed interval time; otherwise no pattern may be detected. Intervals between cluster bins 202 may be measured, for example, using frequency analysis, such as Fast Fourier Transform analysis, which decomposes a sequence of bin 202 values into components of different frequencies. If a specific frequency, pattern or range of frequencies recurs for bins 202, their associated statistical values and time slots may be identified, for example, as recurring.

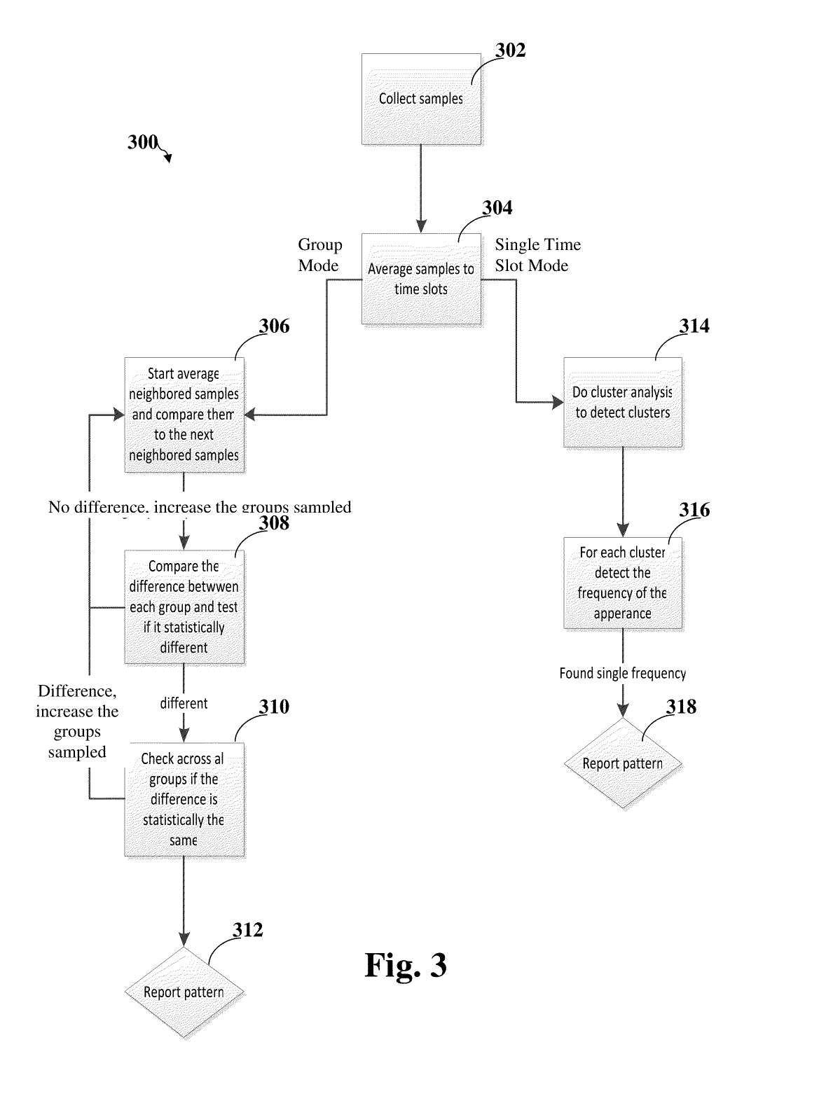

Reference is made to FIG. 3, which is a flowchart of a method 300 for detecting patterns in device behavior in a VSM system in accordance with an embodiment of the invention. The device behavior patterns may be used to identify performance lower than an acceptable threshold, sub-optimal performance, or failed device function that occurs at present, in the past or is predicted to occur in the future.

In operation 302, statistical data samples may be collected, for example, using one or more sensors (e.g., sensors 114 of FIG. 1) monitoring parameters at one or more devices (e.g., recorders 110 of FIG. 1).

In operation 304, the statistical data samples may be divided into bins (e.g., bins 202 of FIG. 2) and the statistical data values may be averaged across each bin. “Bins” may be virtual, e.g., may be memory locations used by a method, and need not be graphically displayed or graphically created.

To detect sub-optimal performance patterns, method 300 may proceed to operation 306 when operating in group mode and/or to operation 314 when operating in single time slot mode.

In operation 306 (in group mode), the average values of neighboring bins may be compared. If there is no difference, the bins may be combined into the same group and compared to other such groups.

In operation 308, the group combined in operation 306 may be compared to another group of the same number of bins. The other group may be the next adjacent group in time or may occur at a predetermined time interval with respect to the group generated in operation 306. If there is no difference (or minimal difference) between the groups, they may be combined into the same group and compared to other groups of the same number of bins. This comparison and combination may repeat to iteratively increase the group size in the group comparison until, for example: (1) a difference is detected between the groups, which causes method 300 to proceed to operation 310, (2) a maximum sized group is reached or (3) all grouping combinations are tested, both of which cause method 300 to end and no pattern to be detected.

In operation 310, all groups may be measured for the same or similar difference detected at the two groups in operation 308. If all (or more than a predetermined percentage) of groups exhibit such a difference, method 300 may proceed to operation 312; otherwise method 300 may end and no pattern may be detected.

In operation 312, a pattern may be reported to a management device (e.g., AMS 116 of FIG. 1). The pattern report may specify which groups of bins record different functionality (e.g., day-time vs. night-time or week vs. week-end), the different functionality of those groups (e.g., 20% decrease in throughput), their time ranges (e.g., 07:00 till 17:00 and 17:00 till 06:00), the periodicity, cycles or intervals of the groups (e.g., decrease in throughput recurs every 12 hours), etc. The pattern report may also provide a root cause analysis as to the cause of the periodic change in functionality and possible solutions to eliminate or stabilize the change.

In operation 314 (in single time slot mode), a cluster analysis may be executed to detect clusters of multiple similar bins.

In operation 316, the frequency of similar bins may be determined for each cluster. If only a single frequency is detected (or frequencies in a substantially small range), the time intervals of similar bins may be substantially constant and periodic and method 300 may proceed to operation 318; otherwise method 300 may end and no pattern may be detected.

In operation 318, a pattern may be reported to the management device.

Other operations or orders of operations may be used. In some embodiments, only one mode (group mode or single time slot mode) may be executed depending on predetermined criteria or system configurations, while in other embodiments both modes may be executed (in sequence or in parallel).

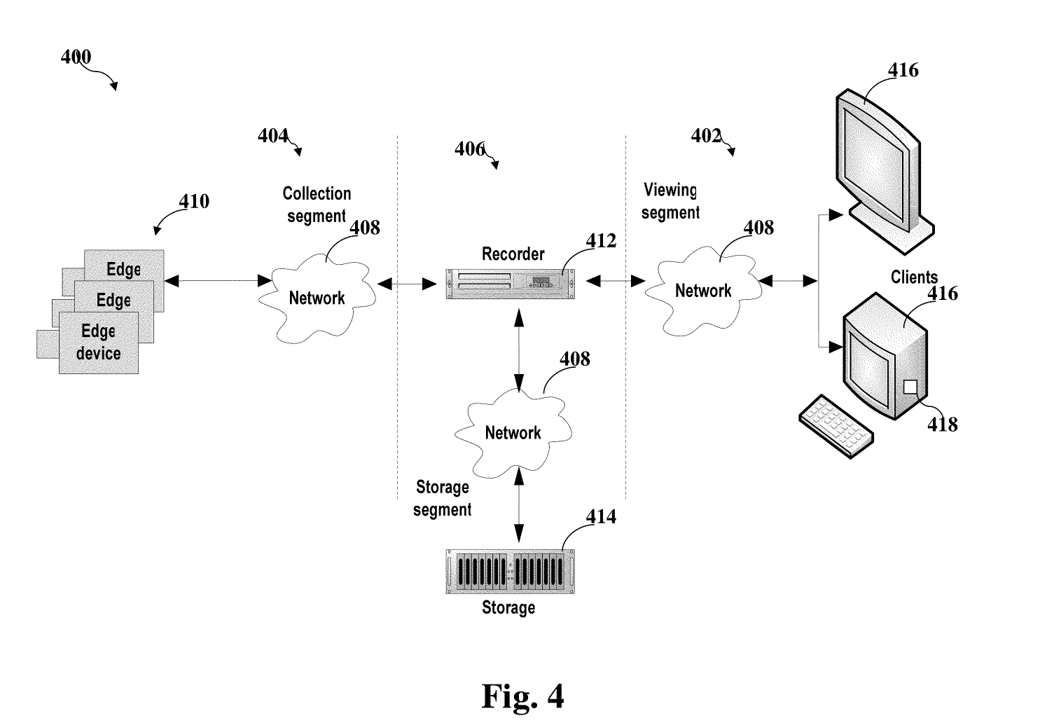

Reference is made to FIG. 4, which schematically illustrates a VSM system 400 in accordance with an embodiment of the invention. In the example of FIG. 4, system 400 monitors quality of experience (QoE) and/or video quality of edge devices, such as, edge devices 111 of FIG. 1, although system 400 may monitor other components or parameters.

System 400 may include a viewing segment 402 (e.g., control and display segment 102 of FIG. 1), a collection segment 404 (e.g., collection segment 104 of FIG. 1) and a storage segment 406 (e.g., storage segment 106 of FIG. 1), all of which may be interconnected by a VSM network 408 (e.g., operated using management segment 108 of FIG. 1).

Collection segment 404 may include edge devices 410 (e.g., edge devices 111 of FIG. 1) to collect data. Storage segment 406 may include a recorder server 412 (e.g., recorder 110 of FIG. 1) to record and manage the collected data and a storage unit 414 (e.g., storage unit 112 of FIG. 1) to store the recorded data.

The overall system video quality may be measured by VSM network 408 combining independent measures of video quality monitored in each different segment 402, 404 and 406. Although each segment's measure may be independent, the overall system video quality measure may aggregate the scores to interconnect system 400 characteristics. System characteristics used for measuring the overall system video quality measure may include, for example:

In collection segment 404:
Camera focus.
Dynamic range.
Compression.
Network errors.

In storage segment 406:
Storage errors.
Network errors.
Recorder server performance.

In viewing segment 402:
Network error.
Client performance.

Quality of experience may measure user viewing experience. Viewed data may be transferred from an edge device (e.g., an IP, digital or analog camera) to a video encoder to a user viewing display, e.g., via a wired or wireless connection (e.g., an Ethernet IP connection) and server devices (e.g., a network video recording server). Any failure or dysfunction along the data transfer route may directly influence the viewing experience. Failure may be caused by network infrastructure problems due to packet loss, server performance origin problems due to a burdened processor load, or storage infrastructure problems due to video playback errors. In one example, a packet lost along the data route may cause a decoding error, for example, that lasts until a next independent intra-frame. This error, accumulated with other potential errors due to different compressions used in the video, may cause moving objects in the video to appear smeared. This may degrade the quality of viewing experience. Other problems may be caused by a video renderer 418 in a display device, such as client 416, or due to bad setting of the video codec, such as, a low bit-rate, frame rate, etc.

The quality of experience may measure the overall system video quality. For example, the quality of experience measure may be automatically computed, e.g., at an AMS, as a combination of a plurality (or all) sensor measures weighed as one quality of experience score (e.g., combining individual KPI sensor values into a single KPIvalue). The quality of experience measure may be provided to a user at a client computer 414, e.g., via a VSM management interface.

Video quality may relate to a plurality of tasks running in system 400, including, for example:

Recording—compressed video from edge devices 410 may be transferred to recorder server 412 and then written to storage unit 414 for retention.

Live monitoring—compressed video from edge devices 410 may be transferred to recorder server 412 to be distributed to multiple clients 416 in real-time.

Playback—compressed video may be read from storage unit 414 and transferred to clients 416 for viewing.

Value Added Services (VAS)—added features, such as, content analysis, motion detection, camera tampering, etc. VAS may be run at recorder server 412 as a centralized process of edge devices 410 data. VAS may receive an image plan (e.g., a standard, non-compressed or raw image or video), so the compressed video may be decoded and transferred to the recorder server 412 in real-time. VAS may influence recording server 412 performance.

Each of these tasks affects the video quality, either directly (e.g., live monitoring and playback tasks) or indirectly (e.g., VAS and recording tasks). These tasks affect the route of the video data transferred from a source edge device 410 to a destination client 416. The more intermediate the task, the longer the route and the higher the probability of error. Accordingly, the quality of experience may measure quality parameters for each of these tasks (or any combination thereof).

Other factors that may affect the quality of experience may include, for example:

System settings—Many parameters may be configured in a complex surveillance system, each of which may affect video quality. Some of the parameters are set as a trade-off between cost and video quality. One parameter may include a compression ratio. The compression ratio parameter may depend on a compression standard, encoding tools and bit rates. The compression ratio, compression standard, encoding tools and bit rates may each (or all) be configurable parameters, e.g., set by a user. In one embodiment, the system video quality measure may be accompanied (or replaced) by a rank and/or recommendation of suggested parameter values estimated to improve or define above standard video quality and/or discouraged parameter values not recommended. A user may set parameter values according to the ranking and preference of video quality.

External equipment—devices or software that are not part of an original system 400 configuration or which the system does not control. External equipment may include network 408 devices and video monitors or screens.

System settings and external equipment may affect video quality by configuration or component failure. Some of the components are external to the system (network devices), so users may be unable to control them via the system itself, but may be able to control them using external tools. Accordingly, the cause of video quality problems associated with system settings and external equipment may be difficult to determine.

The overall system video quality may be measured based on viewing segment 402, collection segment 404 and storage segment 406, for example, as follows.

Collection segment 404—Live video may be captured using edge device 410. Edge device 410 may be, for example, an IP camera or network video encoder, which may capture analog video, converts it to digital compressed video and transfers the digital compressed video over network 408 to recorder server 412. Characteristics of the edge device 410 camera that may affect the captured video quality, include, for example:

Focus—A camera that is out of focus may result in low video detail. Focus may be detected using an internal camera sensor or by analyzing the sharpness of images recorded by the camera. Focus problems may be easily resolved by manually or automatically resetting the correct focus.

Dynamic range—may be derived from the camera sensor or visual parameters settings. In one embodiment, camera sensor may be an external equipment component not directly controlled by system 400. In another embodiment, some visual parameters, such as, brightness, contrast, color and hue, may be controlled by system 400 and configured by a user.

Compression—may be configured by the IP camera or network encoder hardware. Compression may be a characteristic set by the equipment vendor. Encoding tools may define the complexity of a codec and a compression ratio per configured bit-rate. System 400 may control the compression parameters which affects both storage size and bandwidth. Compression, encoding tools and configured bit-rate may define a major part of the QoE and the overall system video quality measure.

Network errors—Video compression standards, such as, H.264 and moving picture experts group (MPEG) 4, may compress frames using a temporal difference to a reference anchor frame. Accordingly, decoding each sequential frame may depend on other frames, for example, until the next independent intra (anchor) frame. A network error, such as a packet loss, may damage the frame structure which may in turn corrupt the decoding process. Such damage may propagate down the stream of frames, only corrected at the next intra frame. Network errors in collection segment 404 may affect all the above video quality related tasks, such as, recording, live monitoring, playback and VAS.

Storage segment 406—may include a collection of write (recording) and read (playback) operations to/from storage unit 414 via separated or combined network segments.

Storage errors—storage unit 414 errors may damage video quality, e.g., break the coherency of the video, in a manner similar to network errors.

Recorder server 412 performance—the efficiency of a processor of recorder server 412 may be affected by incoming and outgoing network loads and, in some embodiments, VAS processing. High processing usage levels may cause delays in write/read operations to storage unit 414 or network 408 which may also break the coherency of the video.

Viewing segment 402—Clients 416 view video received from recorder server 412. The video may include live content, which may be distributed from edge devices 410 via recorder server 412, or may include playback content, which may be read from storage unit 414 and sent via recorder server 412.

Client 416 performance—Client 416 may display more than one stream simultaneously using a multi-stream layout (e.g., a 4×4 grid of adjacent independent stream windows) or using multiple graphic boards or monitors each displaying a separate stream (e.g., client network 126 of FIG. 1). Decoding multiple streams is a challenging task, especially when using high-resolution cameras such as high definition (HD) or mega-pixel (MP) cameras, which typically use high processing power. Another difficulty may occur when video renderer 418 acts as a bottle-neck, for example, using the graphic board memory to write the decoded frames along with additional on-screen displays (OSDs).

Table 12 shows a summary of potential root causes or factors of poor video quality in each segment of system 400 (e.g., indicated by a “V” at the intersection of the segment's column and root cause's row). Other causes or factors may be used.

TABLE 12
Root Causes of Problems in System 400

| | Capture | Storage | Viewing |
|---|---|---|---|
| | segment | segment | segment |
| | 404 | 406 | 402 |
| Camera's focus | V | | |
| Dynamic range | V | | V |
| Compression | V | | |
| Network errors | V | V | V |
| Storage errors | | V | |
| Recorder server | | V | |
| performance | | | |
| Viewing client | | V | |
| performance | | | |

Each video quality factor may be assigned a score representing its impact or significance, which may be weighted and summed to compute the overall system video quality. Each component may be weighted, for example, according to the probability for problems to occur along the component or operation route. An example list of weights for each score is shown, for example, as follows:

TABLE 13
Root Cause Weights

| Score | Weight [%] |
|---|---|
| Camera's focus | 5% |
| Dynamic range | 5% |
| Compression | 25% |
| Collection segment Network errors | 20% |
| Storage errors | 5% |
| Recorder server performance | 10% |
| Storage segment Network errors | 5% |
| Viewing client performance | 10% |
| Viewing segment Network errors | 10% |
| Graphics board (renderer) | 5% |

The camera focus score may be calculated, for example, based on the average edge width of frames. Each frame may be analyzed to find its strongest or most optically clear edge, which is measured as the frame width. Each frame width may be scored, for example, according to the relationships defined as follows:

TABLE 14
Camera Focus Score

| Edge Width | Score |
|---|---|
| 1 | 100 |
| 2 | 100 |
| 3 | 100 |
| 4 | 95 |
| 5 | 80 |
| 6 | 65 |
| 7 | 40 |
| 8 | 20 |
| 9+ | 1 |

The camera focus scores for all the frames may be averaged to obtain an overall camera focus score (e.g., considering horizontal and/or vertical edges). The average edge width may represent the camera focus since, for example, when the camera is in focus, the average score for the edge width is relatively small and when the camera is out of focus, the average score for the edge width is relatively large. In one example, if the first strong edge in a frame begins at the 15^{th} column and ends at the 19^{th} column, then the edge width may be calculated to be 5 pixels and the score may be 80 (defined by the relationship in the fifth entry in table 14).

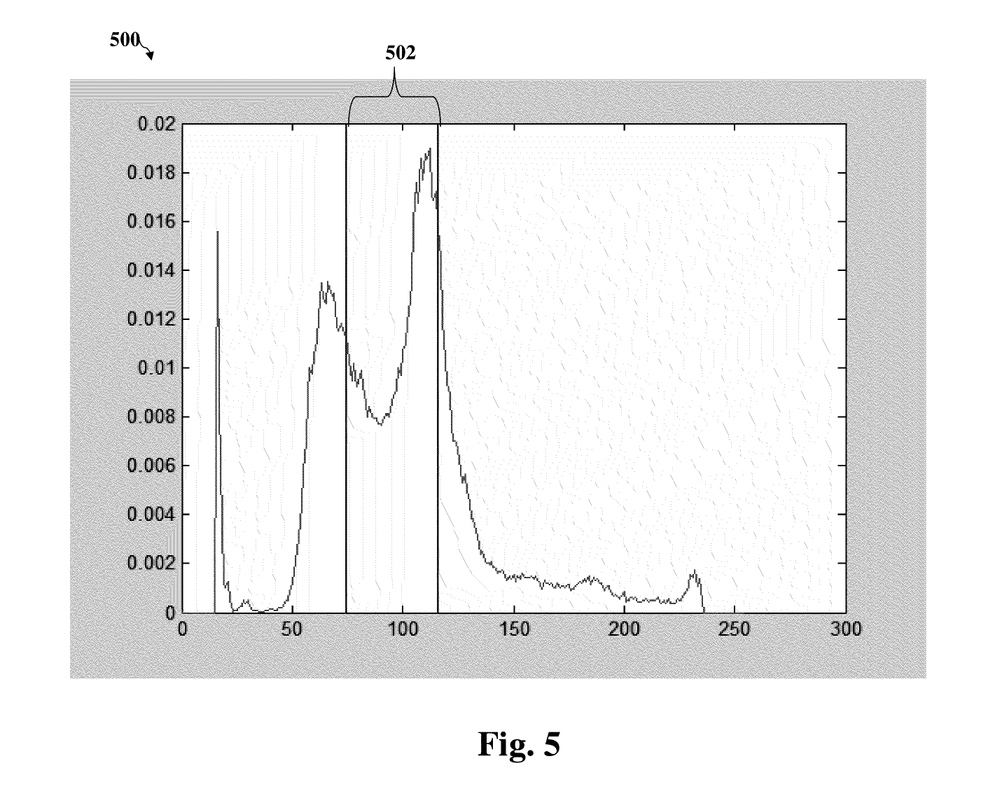

The dynamic range score may be calculated, for example, using a histogram, such as, histogram 500 of FIG. 5. FIG. 5 shows a histogram representing image luminance values (x-axis) vs. a number of pixels in a frame having that luminance (y-axis). Other statistical data or image properties may be depicted, such as, contrast, color, etc. A processor (e.g., AMS processor 140 of FIG. 1) may use a camera tampering algorithm to process histogram 500 statistics to determine a dynamic range of a captured scene and an alert for a scene that is determined to be too dark/bright. For example, if histogram 500 values are spread evenly across a wide range of luminescence values, the dynamic range may large. In contrast, when histogram 500 values are concentrated in a narrow range of luminance values, the dynamic range may be small. The dynamic range may be assigned a score, for example, representing the width of the dynamic range (e.g., a score for either dynamic or not) or representing the brightness or luminescence of the dominant range (e.g., a score for either bright or dark). A sliding window 502 (e.g., a virtual data structure) may be slid along histogram 500, for example, to a position in which window 502 has a minimum width that still includes at least 50% of the frame pixels. The result may be normalized (e.g., by dividing the maximum histogram 500 value by the total number of pixels in the image) to match a percentage grade.

The compression video quality score may be calculated, for example, using a quantization value averaged over time, Q. If the codec rate control uses a different quantization level for each macroblock (MB) (e.g., as does H.264), then additional averaging may be used for each frame. The averaged quantization value, Q, may be mapped to the compression video quality score, for example, as follows:

TABLE 15
Compression Score

| Averages Quantization Value, Q | Score |
|---|---|
| Q < 20 | Excellent (100) |
| 20 < Q < 30 | Very good (90) |
| 30 < Q < 40 | Good (80) |
| Q > 40 | Potential for a problem (60) |

The compression video quality score may be defined differently for each different compression standard, since each standard may use different quantization values. In general, the quantization range may be divided into several levels or grades, each corresponding to a different compression score.

The network errors score may be calculated, for example, by counting the number of packet losses at the receiver side (e.g., recorder server 412 and/or client 416 of FIG. 4) and defining thresholds for network quality according to average packet loss per period of time (e.g., per second). Since the packaging of frames into packets may be different for each edge device 410 vendor, the measure of average packet loss per period of time may be calculated using percentages. 100% may be the total packets per period of time. The relationship between packet loss percentages and the network errors score may be defined, for example, as follows (other values may be used):

TABLE 16
Network Error Score

| Packet loss/Sec | Score |
|---|---|
| PL/S < 0.005% | Excellent |
| 0.005% < PL/S < 0.01% | Very good |
| 0.01% < PL/S < 0.05% | Good |
| PL/S > 0.5% | Potential for a problem |

The recorder server performance score and the viewing client performance score may each measure the average processor usage or CPU level of recorder server 412 and client 416, respectively. The peak processor usage or CPU level may be taken in account by weighting the average and the peak levels with a ratio of, for example, 3:1.

TABLE 17
Recorder server and Client Performance Scores

| Average CPU | Score |
|---|---|
| CPU < 50% | Excellent |
| CPU < 60% | Very good |
| CPU < 75% | Good |
| CPU > 75% | Potential for a problem |

The storage error score may measure the read and write time from storage unit 414, for example, as follows (other values may be used).

TABLE 18
Storage Error Score

| RD/WR time | Score |
|---|---|
| Time < 20 mSec | Excellent |
| 20 mSec < Time < 40 mSec | Very good |
| 40 mSec < Time < 80 mSec | Good |
| Time > 80 mSec | Potential for a problem |

The graphic board error score may be calculated, for example, by counting the average rendering frame skips as a percentage of the total number of frames, for example, as follows (other values may be used):

TABLE 19
Graphic Board Error Scores

| Frame skips | Score |
|---|---|
| Skips = 0 | Excellent |
| Skips < 3% (1 frame) | Very good |
| Skips < 10% (2-3 frames) | Good |
| Skips < 20% (5-6 frames) | Potential for a problem |

The scores above may be combined and analyzed by the VSM system to compute the overall system video quality measurement score, for example, as shown in table 20 (other values may be used).

TABLE 20
Performance Analysis

| | Sub score | | Score | Weight | | Potential |
|---|---|---|---|---|---|---|
| Measure | feature | Result | mapping | [%] | Total | problem |
| Camera's focus | Edge | 3 | 100 | 5% | 5.00 | V |
| | width | | | | | |
| Dynamic range | Histogram | 70 | 27 | 5% | 1.35 | X |
| | width | | | | | |
| Compression | Q | 27 | 90 | 25% | 22.50 | V |
| Collection | PL/Sec | 0.01% | 90 | 20% | 18.00 | V |
| segment Network | | | | | | |
| errors | | | | | | |
| Storage errors | Time | 25 mSec | 90 | 5% | 4.50 | V |
| Recorder server | CPU | 70% | 80 | 10% | 8.00 | V |
| performance | | | | | | |
| Storage segment | PL/Sec | 0.01% | 90 | 5% | 4.50 | V |
| Network errors | | | | | | |
| Viewing client | CPU | 75% | 60 | 10% | 6.00 | X |
| performance | | | | | | |
| Viewing segment | PL/Sec | 0.01% | 90 | 10% | 9.00 | V |
| Network errors | | | | | | |
| Graphics board | Skips | 2% | 90 | 5% | 4.50 | V |
| (renderer) | | | | | | |
| Total video quality | | | | | 83.35 | V |
| score | | | | | | |

For each different video quality factor (each different row in Table 20), the raw video quality result (e.g., column 3) may be mapped to scaled scores (e.g., column 4) and/or weighted (e.g., with weights listed column 5). Once mapped and/or weighted, the total scores for each component (e.g., column 6) may be combined in the performance function to generate a total video quality score (e.g., column 6, bottom row). The total video quality scores (e.g., for each factor and for the overall system) may be compared to one or more thresholds or ranges to determine the level or category of video quality. In the example shown in Table 20, there are two categories, potentially problematic video quality (V) and not problematic video quality (X)) defined for each factor and for the overall system (although any number of categories may be used).

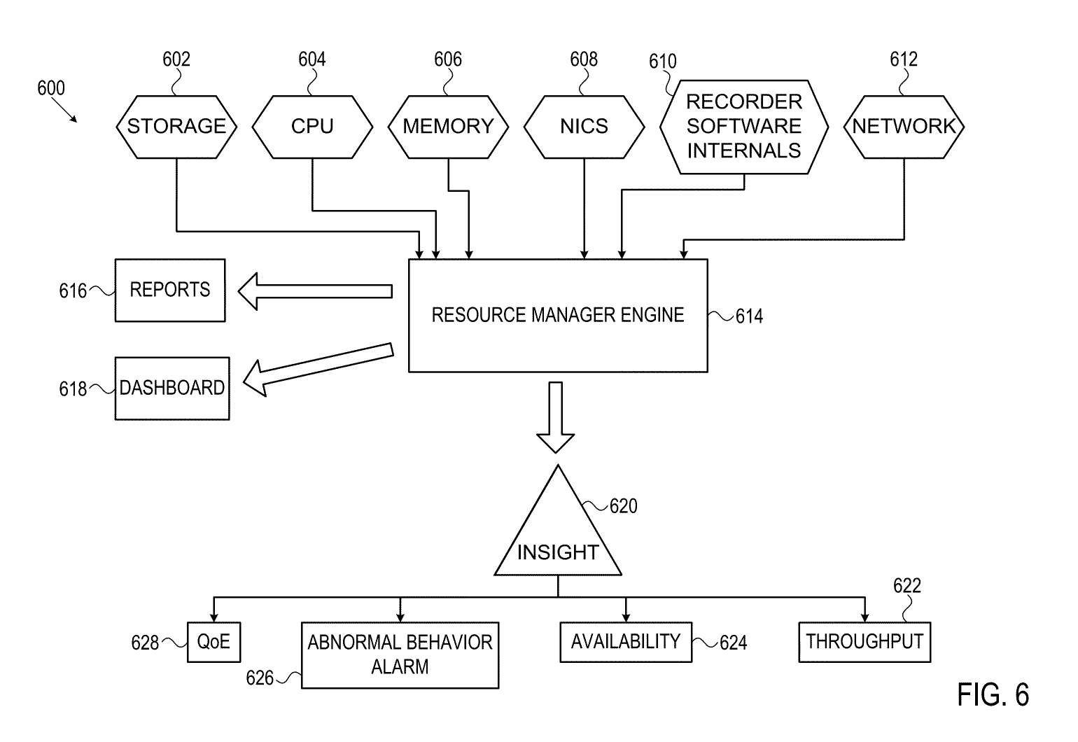

Reference is made to FIG. 6, which schematically illustrates data structures in a VSM system 600 in accordance with an embodiment of the invention. The VSM system 600 (e.g., system 100 of FIG. 1) may include a storage unit 602 (e.g., storage unit 112 and/or 152 of FIG. 1), a recorder 610 (e.g., recorder 110 of FIG. 1) and a network 612 (e.g., network 408 of FIG. 4), each of which may transfer performance data to a resource manager engine 614 (e.g., AMS 116 of FIG. 1). Recorder 610 may include a processor (CPU) 604, a memory 606 and one or more NICs 608.

Resource manager engine 614 may input performance parameters and data from each system component 602-612, e.g., weighed in a performance function, to generate a performance score defining the overall quality of experience in system 600. The input performance parameters may be divided into the following categories, for example (other categories may also be used):

Storage.

Network (hardware and performance).

Recorder (software and hardware).

In addition to the performance score, resource manager engine 614 may output a performance report 616 including performance statistics for each component 602-612, a dashboard 618, for example, including charts, graphs or other interfaces for monitoring the performance statistics (e.g., in real-time), and insights 620 including logical determinations of system 600 behavior, causes or solutions to performance problems, etc.

Insights 620 may be divided into the following categories, for example (other categories may also be used):
Throughput 622—If the total write throughput to the disk is changes, throughput 622 may provide the reason for the change.
Availability 624—may grade the site availability as a function of recorder and/or edge device availability.
Abnormal behavior alarm 626—may provide alarms, such as, for example:
   Predictive alarms.
   Status alarms.
   Pattern alarms.
Quality of experience 628—may grade video quality at a client or user device. If the grade is below a threshold, quality of experience 628 may provide a reason for the change.

Other data structures, insights or reports including other data may be used.

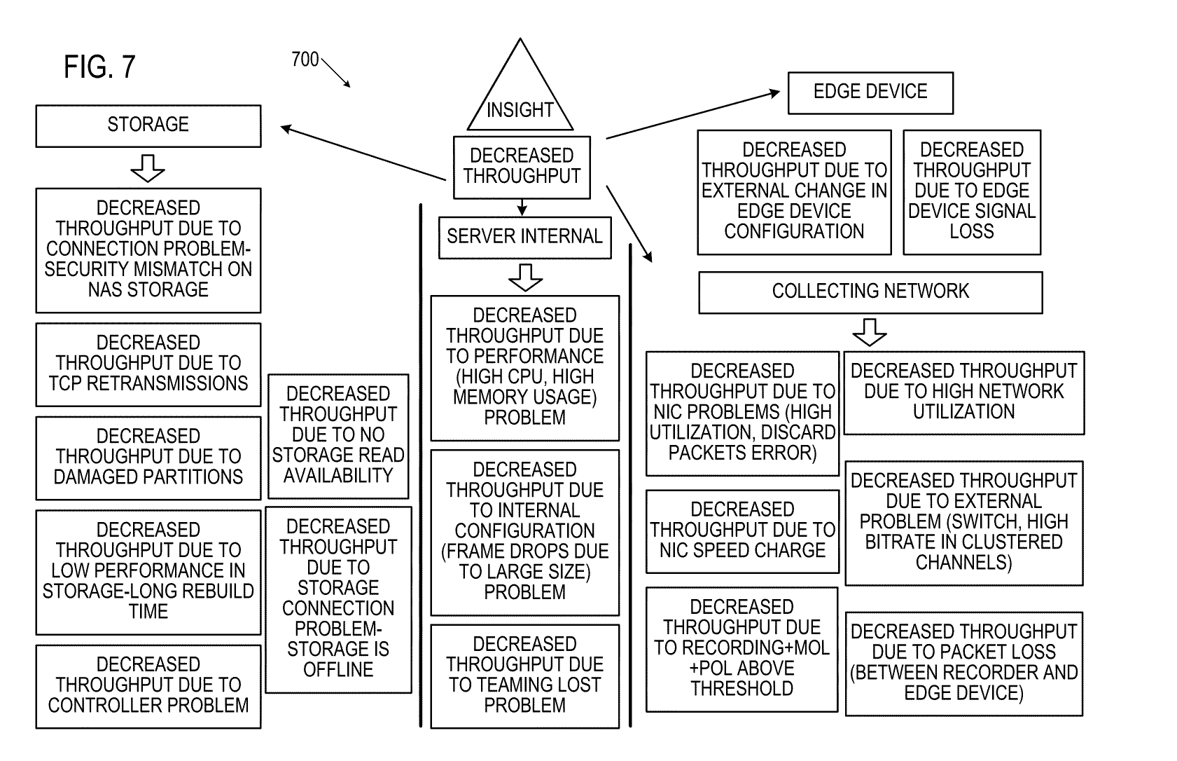

Reference is made to FIG. 7, which schematically illustrates throughput insights 700 generated by the resource manager engine of FIG. 6, in accordance with an embodiment of the invention.

Throughput insights 700 may be generated based on throughput scores or KPIs computed using data collected by system probes or sensors (e.g., sensor 114 of FIG. 1). Throughput insights 700 may be divided into categories defining the throughput of, for example, the following devices (other categories may also be used):

Edge device.

Storage.

Collecting network.

Server internal.

Other insights or reports including other data may be generated.

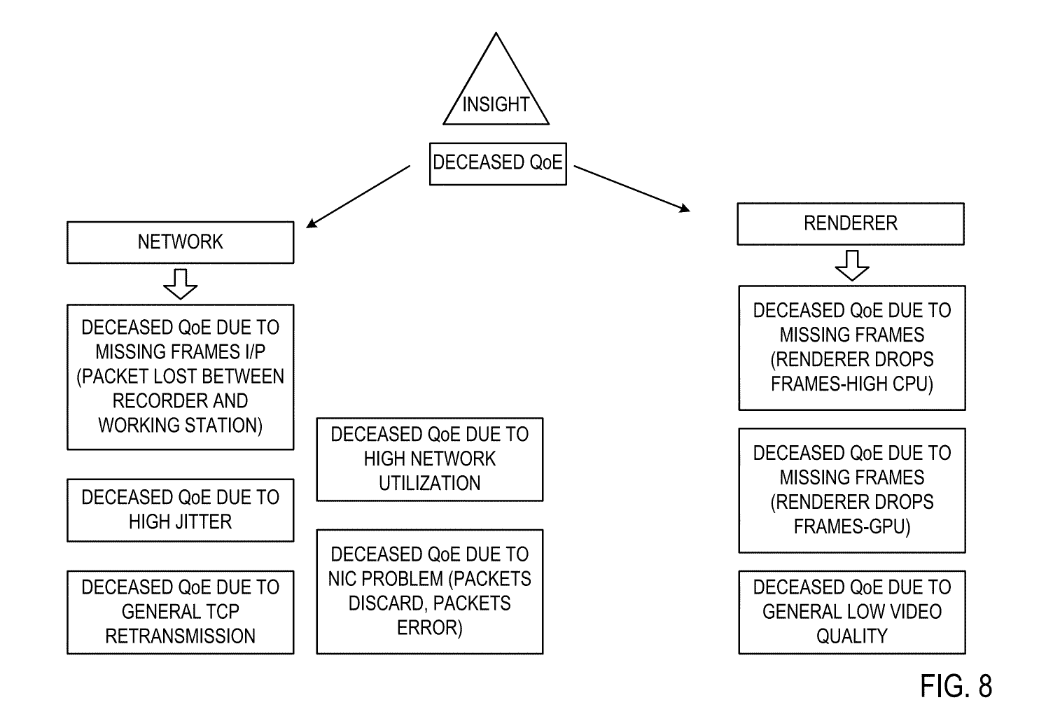

Reference is made to FIG. 8, which schematically illustrates quality of experience insights 800 generated by the resource manager engine of FIG. 6, in accordance with an embodiment of the invention.

Quality of experience insights 800 may be generated based on quality of experience scores or statistics computed using data collected by system 600 probes or sensors. Quality of experience insights 800 may be divided into the following categories defining the performance of, for example, the following devices (other categories may also be used):

Renderer.

Network.

Other insights or reports including other data may be generated.

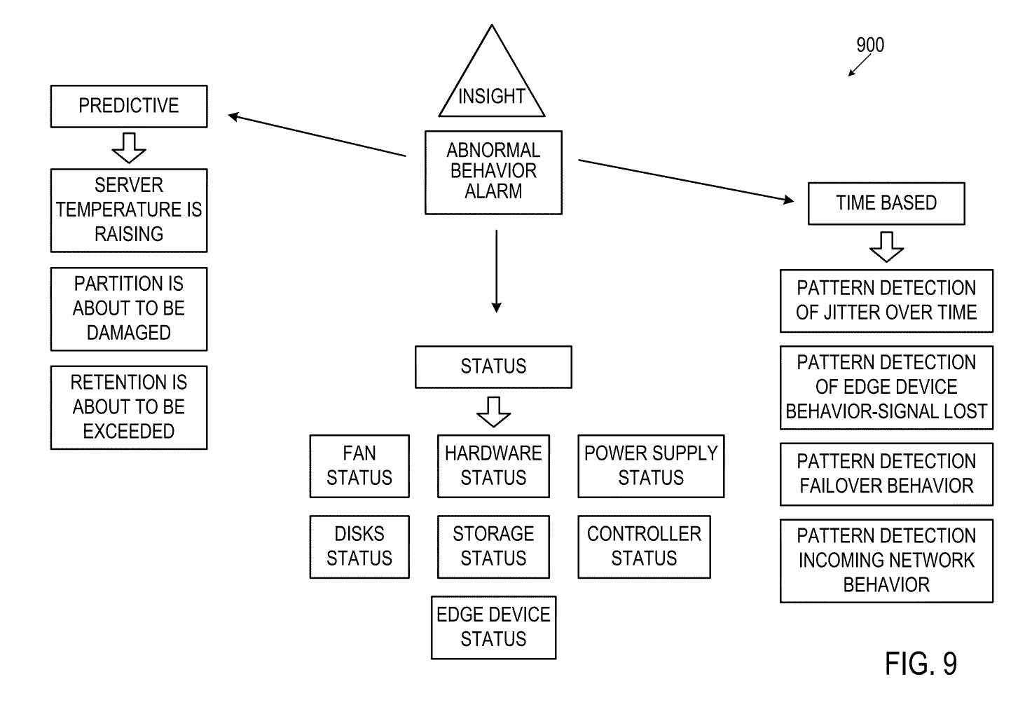

Reference is made to FIG. 9, which schematically illustrates abnormal behavior alarms 900 generated by the resource manager engine of FIG. 6, in accordance with an embodiment of the invention.

Abnormal behavior alarms 900 may be generated based on an abnormal behavior score or KPIs computed using data collected by system 600 probes or sensors. Abnormal behavior alarms 800 may be divided into the following categories, for example, (other categories and alarms may also be used):

Predictive alarm.

Status alarm.

Time based alarm.

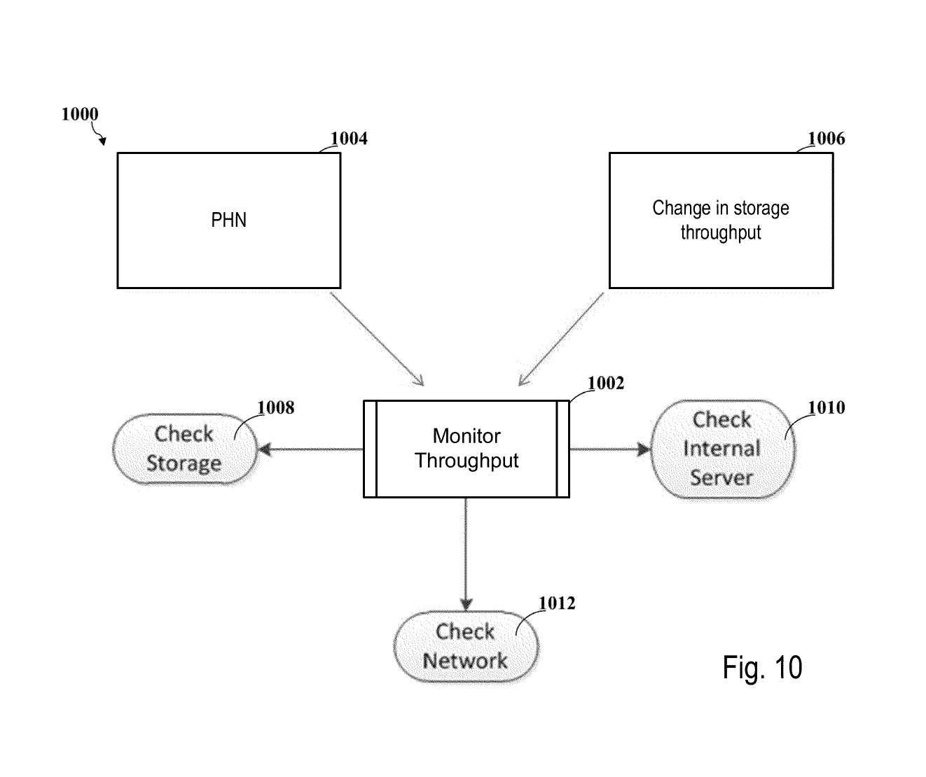

Reference is made to FIG. 10, which schematically illustrates a workflow 1000 for monitoring storage throughput 1002 in accordance with an embodiment of the invention.

Workflow 1000 may include one or more of the following triggers for monitoring throughout 1002:
Pool head nulls (PHN) 1004. If there are no available buffers (or less than a threshold number thereof) to write to, a process or processor may proceed to monitoring storage throughput 1002.

A change in storage throughput 1006. If a current storage throughput value is less than a predetermined minimum threshold or greater than a predetermined maximum threshold, a process or processor may proceed to monitoring storage throughput 1002.

Monitoring throughout 1002 may cause a processor (e.g., AMS processor 140 of FIG. 1) to check or monitor the throughput of, for example, one or more of the following devices (other checks may also be used):

Check storage throughput 1008.

Check internal server throughput 1010.

Check network throughput 1012.

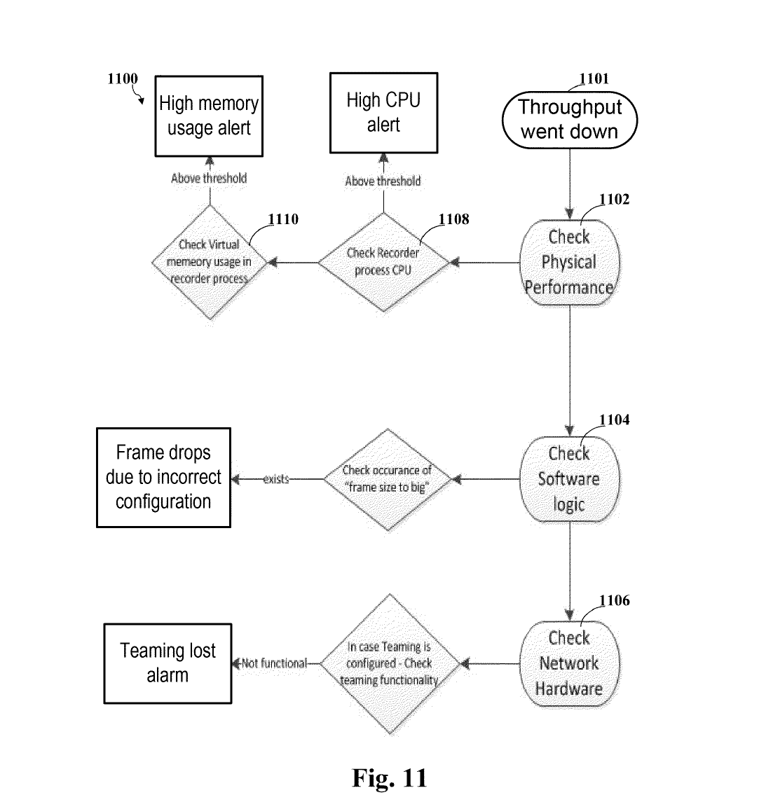

Reference is made to FIG. 11, which schematically illustrates a workflow 1100 for checking internal server throughput 1010 in accordance with an embodiment of the invention. In one example, workflow 1100 may be triggered if a decrease in throughput is detected in operation 1101, e.g., that falls below a predetermined threshold.

Internal server throughput check 1010 may be divided into the following check categories, for example (other categories may also be used):
Physical performance check 1102:
   CPU usage check 1108—determine if the recorder performance is damaged by high CPU usage. High CPU usage may cause an operating system to delay write operations and network collecting operations.
   Memory usage check 1110—determine if the recorder performance is damaged by high memory usage. High memory usage may cause the operating system to have insufficient resources to execute write operations and network collecting operations.
Software logic check 1104: Determine if the current recorder configuration is causing a bottleneck. For example, the configuration settings may define a maximal frame size, where if a frame is received with a size bigger than the maximal frame size, this frame may be dropped.
Network hardware check 1106: Determine if teaming functionality is configured. If teaming functionality is configured, determine if the teaming functionality is activated (and the server can handle the network throughput) or if the functionality is disrupted.

Other checks or orders of checks may be used. For example, in FIG. 11, checks 1102, 1104 and 1106 are ordered; however checks 1102, 1104 and 1106 may be ordered differently in any other order or may be executed in parallel.

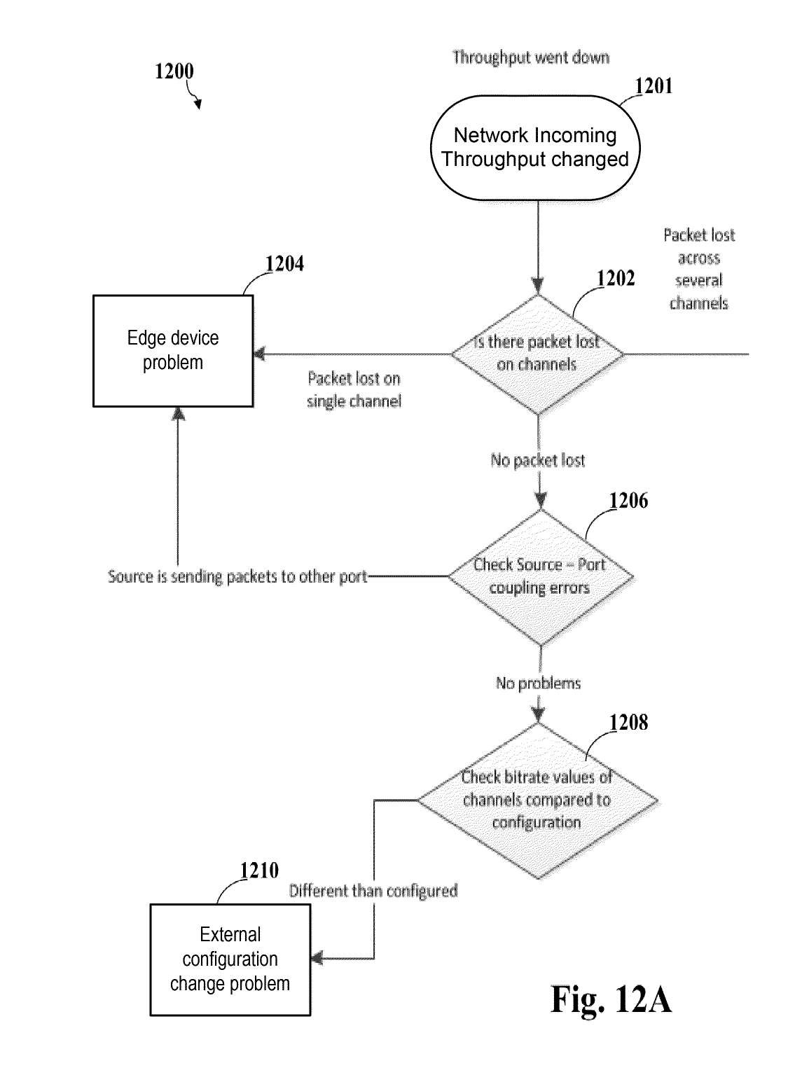

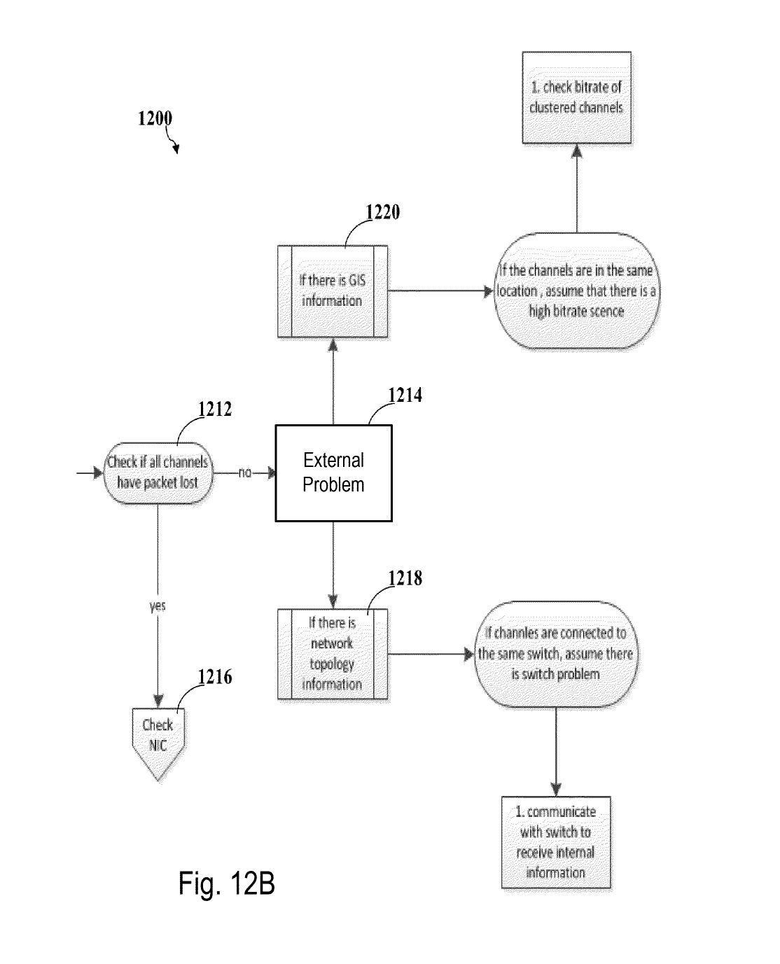

Reference is made to FIGS. 12A and 12B, which schematically illustrate a workflow 1200 for checking if a network issue causes a decrease in storage throughput in accordance with an embodiment of the invention. FIGS. 12A and 12B are two figures that illustrate a single workflow 1200 separated onto two pages due to size restrictions.

In one example, workflow 1200 may be triggered if a decrease in network throughput is detected in operation 1201, e.g., that falls below a predetermined threshold.

Workflow 1200 may initiate, at operation 1202, by determining if packets are lost over network channels. If packets are lost over a single channel, it may be determined in operation 1204 that the source of the problem is an edge device that sent the packet. If however, no packets are lost, packets from each network stream may be checked in operation 1206 for arrival at the configured destination port on the server. If two channels or more stream to the same port, frames are typically discarded and it may be determined in operation 1204 that the cause of the problem is the edge device. If however, there are no port coupling errors, in operation 1208, it may be checked if the actual bit-rate of the received data is the same as the configured bit-rate. If the actual detected bit-rate is different than (e.g., less than) the configured bit-rate, it may be determined in operation 1210 that the source of the problem is an external change in configuration.

If it is determined in operation 1202 that packets are lost, a process or processor may proceed to operation 1212 of FIG. 12B. In operation 1212 it may be determined if there are packets lost on several (or all) channels. If the packet loss does not occur on all channels, the NIC may be checked in operation 1216 to see if that component is the cause of the decrease in throughout. If however there is packet loss on several (or all) channels, it may be determined in operation 1214 that the cause of the decrease in throughout is an external issue. If there is network topology information it may be determined in operation 1218 that a network switch (e.g., of network 612 of FIG. 6) is the cause the decrease in throughput. If there is geographic information system (GIS) information, it may be determined in operation 1220 that a cluster of channels is the cause if the problem.

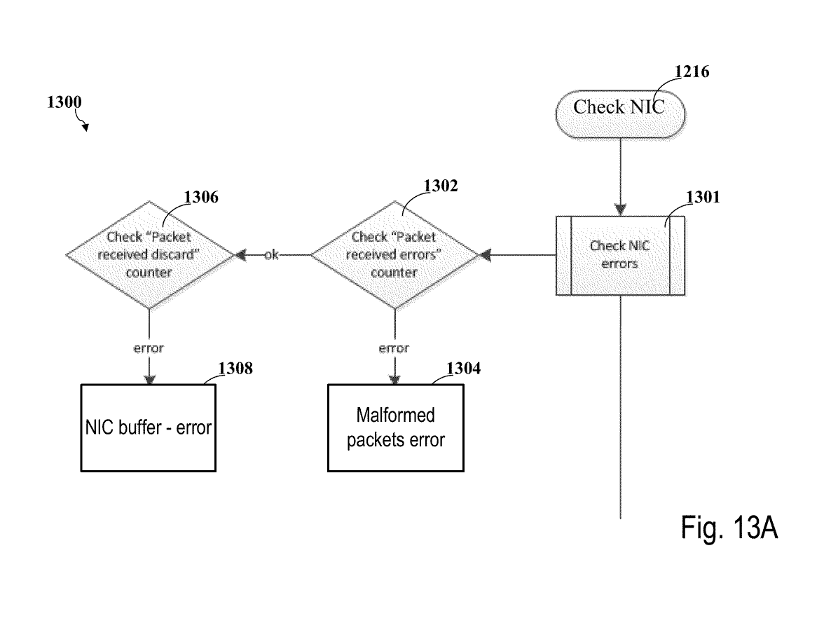

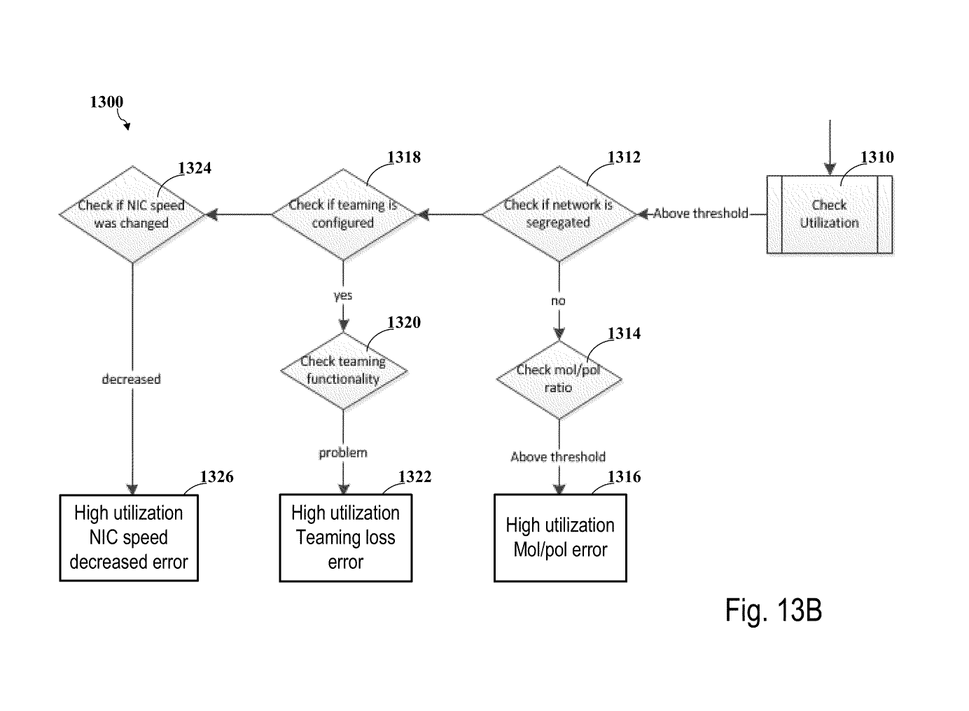

Reference is made to FIGS. 13A and 13B, which schematically illustrate a workflow 1300 for checking if a decrease in storage throughput is caused by a network interface card in accordance with an embodiment of the invention. FIGS. 13A and 13B are two figures that illustrate a single workflow 1300 separated onto two pages due to size restrictions. Workflow 1300 may include detailed steps of operation 1216 of FIG. 12B. Workflow 1300 may include a check for NIC errors 1301 and a separate check for NIC utilization 1310, which may be executed serially in sequence or in parallel.

The check for NIC errors 1301 may initiate with operation 1302, in which packets may be checked for errors. If there are errors, it may be determined in operation 1304 that the cause of the decreased throughout is malformed packets that cannot be parsed, which may be a network problem. If however, there are no malformed packets, it may be determined in operation 1306 if there are discarded packets (e.g., packets that the network interface card rejected). If there are discarded packets, it may be determined in operation 1308 that the cause of the problem is a buffer in the network interface card, which discards packets when filled.

NIC utilization check 1310 may check if NIC utilization is above threshold. If so, a process may proceed to operation 1312-1326 to detect the cause of the high utilization. In operation 1312, the network may be checked for segregation. If the network is not segregated, a ratio, for example, of mol to pol amounts or percentages (%), may be compared to a predetermined threshold in operation 1314, where “mol” is the amount of live video that passes from a recorder (e.g., recorder 110 of FIG. 1) to a client (e.g., user devices 122, 124 or 126 of FIG. 1 or client 416 of FIG. 4) and “pol” is the playback video that passes from the recorder to the client. If the ratio exceeds a predetermined threshold, the NIC may not be able to collect all incoming data and it may be determined in operation 1316 that the high ratio is the cause the decreased throughput. If the network is segregated, the teaming configuration may be checked in operation 1318. If teaming is configured, the functionality of the teaming may be checked in operation 1320. If there is a problem with the teaming configuration it may be determined in operation 1322 that an interruption or other problem in the teaming configuration is the cause the decrease in throughput. In operation 1324, the network interface card speed may be checked. If the network interface card speed decreases, it may be determined in operation 1326 that the cause the decrease in throughput is the slow network interface card speed.

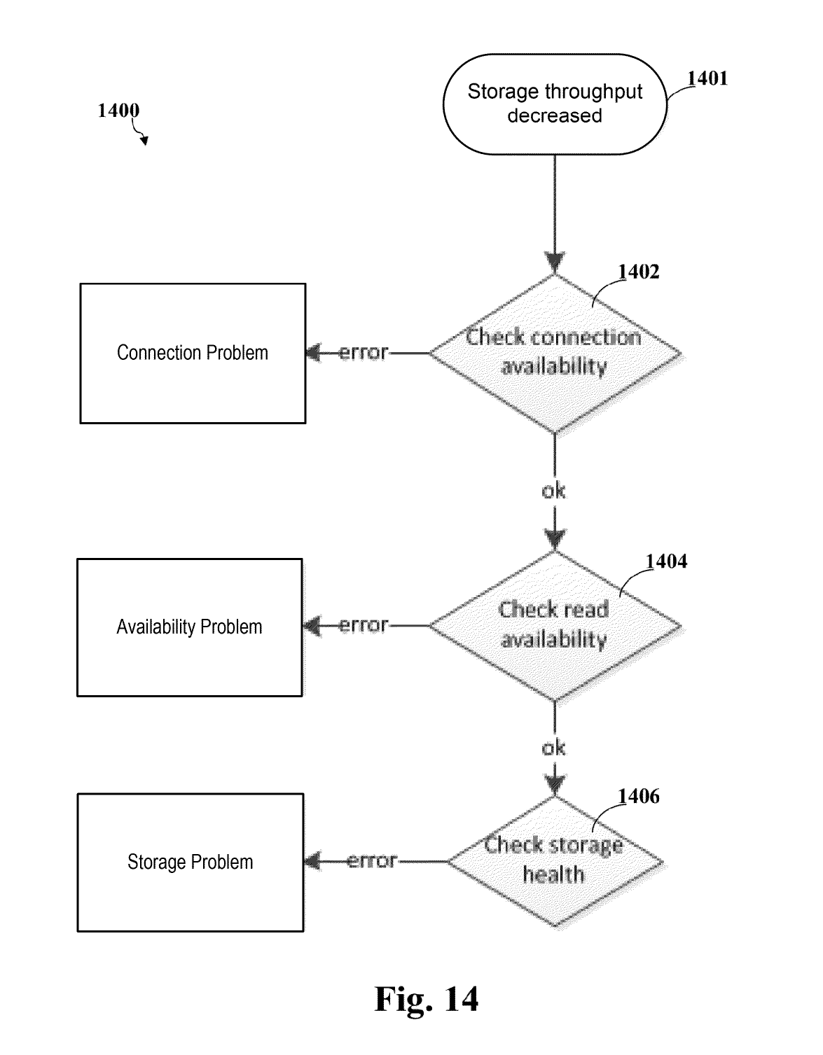

Reference is made to FIG. 14, which schematically illustrates a workflow 1400 for checking or determining if a cause for a decrease in storage throughput is the storage itself, in accordance with an embodiment of the invention. In one example, workflow 1400 may be triggered if a decrease in storage throughput is detected in operation 1401, e.g., that falls below a predetermined threshold.

The checks of workflow 1400 may be divided into the following check categories, for example (other categories may also be used):

Checking connection availability 1402.

Checking read availability 1404 (e.g., checking the storage is operational).

Checking storage health 1406.

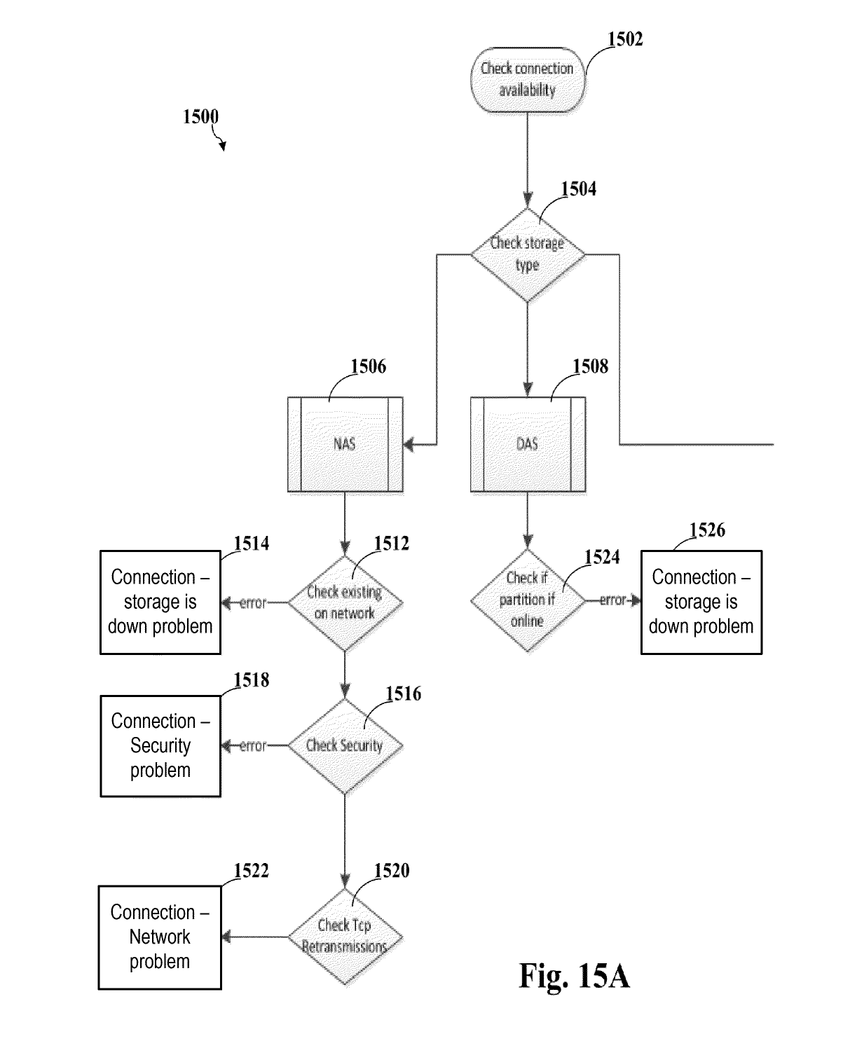

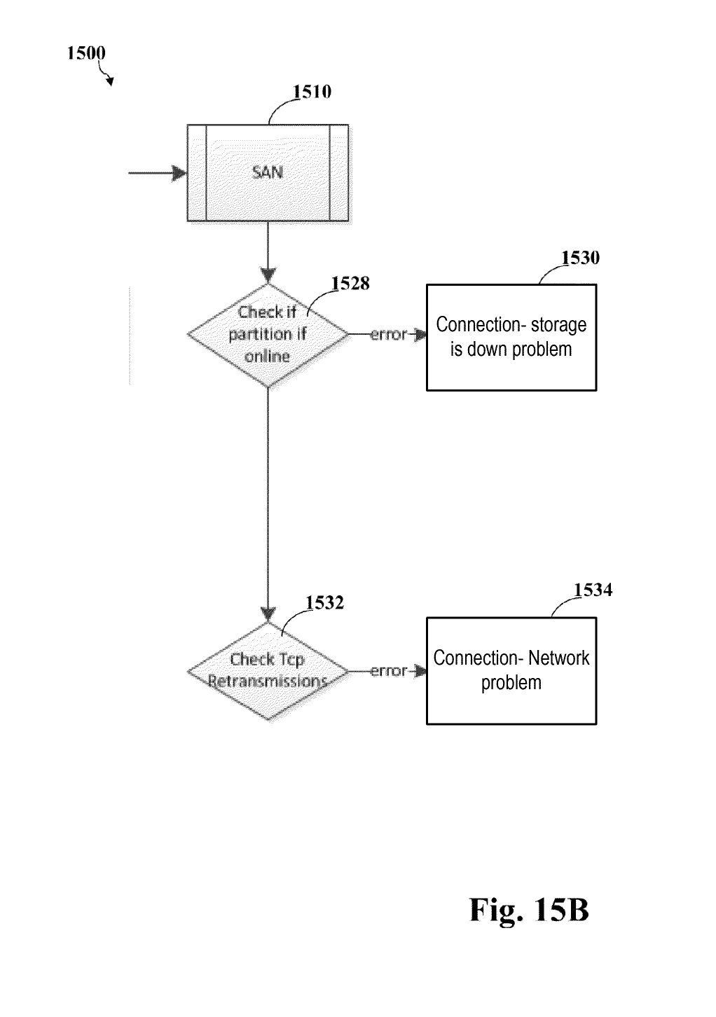

Reference is made to FIGS. 15A and 15B, which schematically illustrate a workflow 1500 for checking for connection availability in accordance with an embodiment of the invention. FIGS. 15A and 15B are two figures that illustrate a single workflow 1500 separated onto two pages due to size restrictions. Workflow 1500 may include detailed steps of operation 1402 of FIG. 14.

In operation 1502, the availability of one or more connection(s) to the storage unit may be checked to determine if the cause of the decrease in storage throughput is the connection(s). The type of storage connection may be determined in operation 1504. Storage unit may have the following types of connections (other storage connections may be used):

NAS—determined to be a network attached storage type in operation 1506.

DAS—determined to be a direct attached storage type in operation 1508.

SAN—determined to be a storage area network type in operation 1510.

For a NAS storage connection, it may be determined in operation 1512 if the storage unit is available over the network. If not, it may be determined in operation 1514 that the cause of the decreased throughput is that the storage is offline. If the storage is online, security may be checked in operation 1516 to determine if there are problem with security settings or permissions for writing to the storage. NAS may use a username and password authentication to be able to read and write to storage. If there is a mismatch of security credentials, it may be determined in operation 1518 that security issues are the cause of the decreased in throughput. In operation 1520, the network performance may be checked, for example, for a percentage (or ratio or absolute value) of transmission control protocol (TCP) retransmissions. If TCP retransmissions are above a predetermined threshold, it may be determined in operation 1522 that network issues are the cause of the decrease is throughput.

For a DAS storage connection, it may be determined in operation 1524 if the storage unit is available over the network. If not (e.g., if at least one of the storage partitions is not available), it may be determined in operation 1526 that the cause of the decreased throughput is that the storage is offline.

For a SAN storage connection, it may be determined in operation 1528 if the storage unit is available over the network. If not, it may be determined in operation 1530 that the cause of the decreased throughput is that the storage is offline. If the storage is online, the network performance may be checked in operation 1532, for example, for a percentage of TCP retransmissions. If TCP retransmissions are above a predetermined threshold, it may be determined in operation 1534 that network issues are the cause of the decrease is throughput.

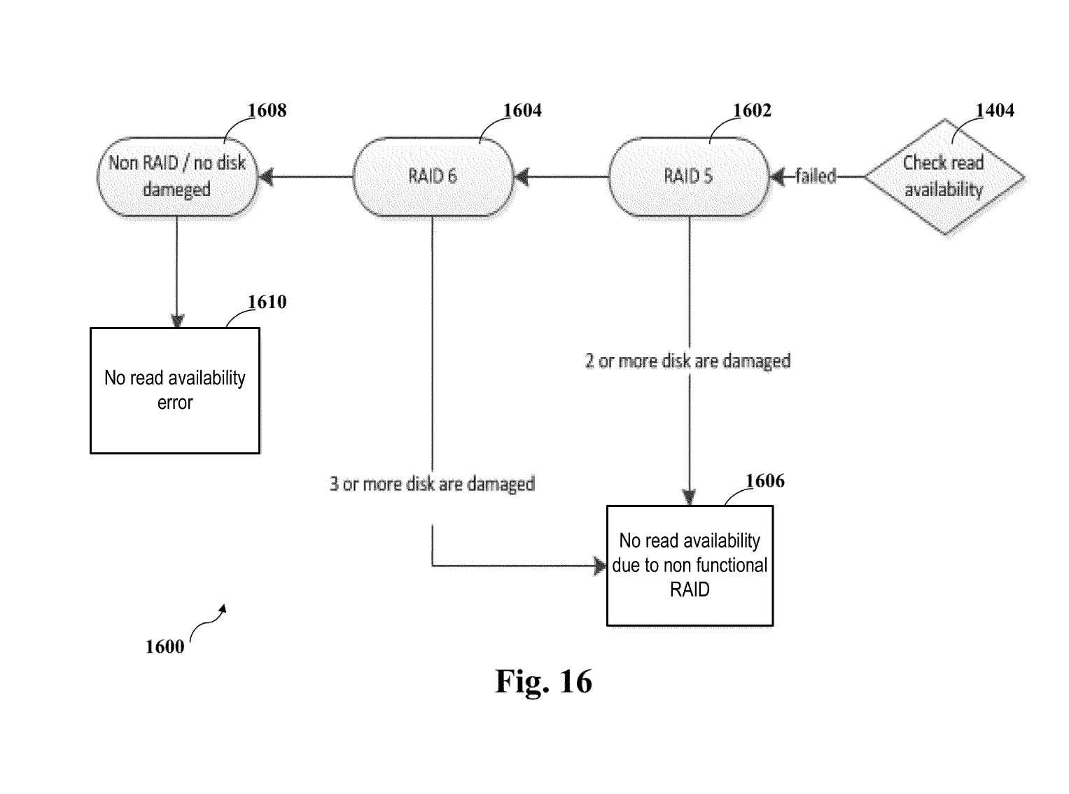

Reference is made to FIG. 16, which schematically illustrates a workflow 1600 for checking the cause of a decrease in storage throughput if a read availability test fails, in accordance with an embodiment of the invention. Workflow 1600 may include detailed steps following determining that there is no read availability in operation 1404 of FIG. 14.

The type of storage unit may be determined to be RAID 5 in operation 1602 and RAID 6 in operation 1604. If the storage unit is a RAID 5 unit and two or more disks are damaged or if the storage unit is a RAID 6 unit and three or more disks are damaged, it may be determined in operation 1606 that the cause of the problem is a non-functional RAID storage unit. If in operation 1608, it is determined that the storage unit is not a RAID unit or that the storage unit is a RAID unit but that no disks in the unit are damaged, it may be determined in operation 1610 that a general failure problem, not the storage unit, is the cause of the decreased storage throughput.

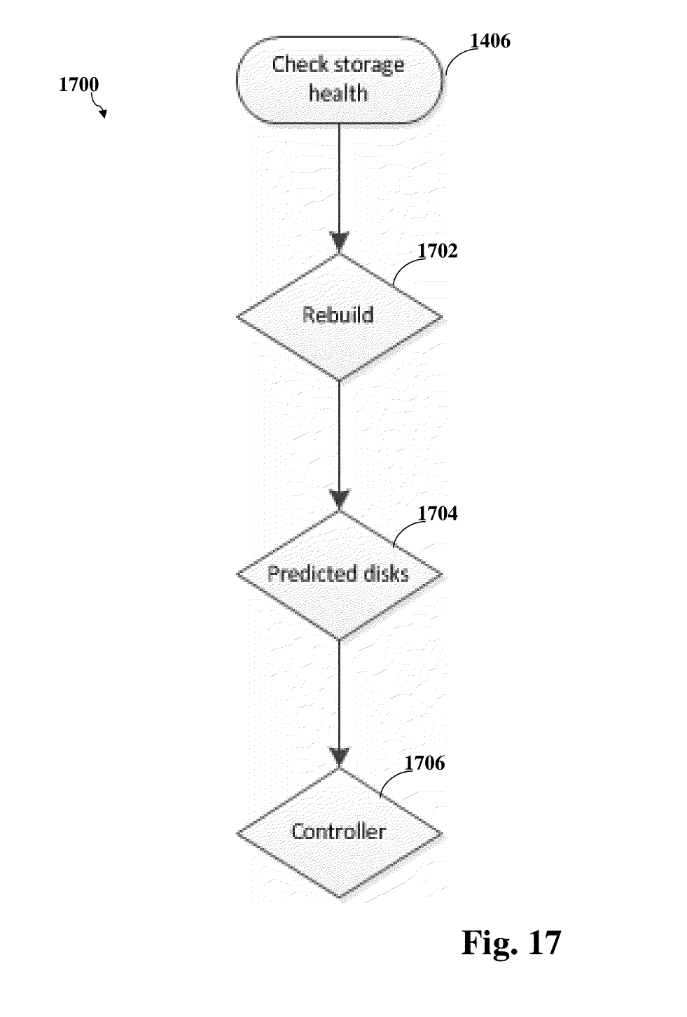

Reference is made to FIG. 17, which schematically illustrates a workflow 1700 for checking the cause of a decrease in storage throughput if a read availability test fails, in accordance with an embodiment of the invention. Workflow 1700 may include detailed steps of operation 1406 of FIG. 14.

The operations to check storage health in workflow 1700 may be divided into the following categories, for example (other categories may also be used):
In operation 1702, a check on a rebuild operation, in which disks may be rebuilt to replace damaged data, may be executed.
In operation 1704, predicted disk errors may be checked. If there is a greater than threshold percent of predicted disk errors in the storage units, those predicted errors may be the cause of the degraded throughput.
In operation 1706, it may be checked to determine if the controller decreases reading or writing resources in the storage, for example, due to problems, such as, low battery power, problems with an NIC, etc.

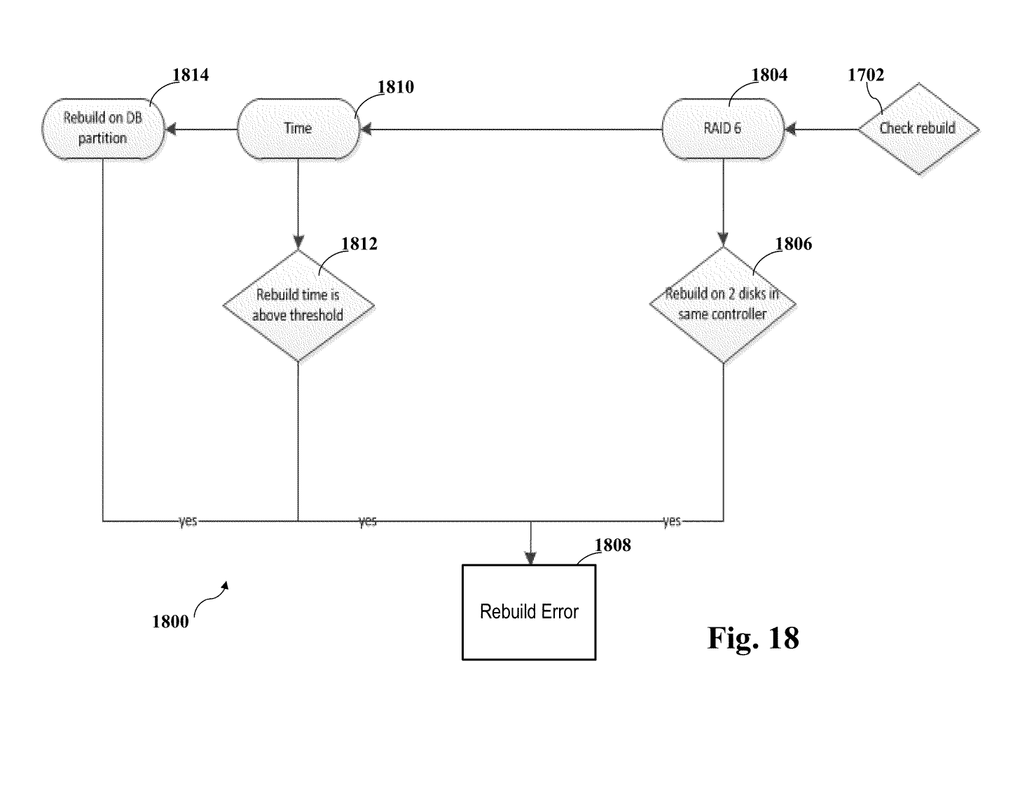

Reference is made to FIG. 18, which schematically illustrates a workflow 1800 for checking if a rebuild operation is the cause of a decrease in the storage throughput, in accordance with an embodiment of the invention. Workflow 1800 may include detailed steps of operation 1702 of FIG. 17 to check the rebuild operation.

If the storage is determined to be RAID 6 in operation 1804 and a rebuild operation is determined to be executed on two of the disks at the same controller in operation 1806, it may be determined in operation 1808 that the rebuild operation is the cause of the decrease in throughput. If the total rebuild time measured in operation 1810 is determined to be above an average rebuild time in operation 1812, it may be determined in operation 1808 that the rebuild operation is the cause of the decrease in performance. If in operation 1814 a database partition of the recorder is determined to be the unit that is being rebuilt, it may be determined in operation 1808 that the rebuild operation is the cause of the decrease in performance.

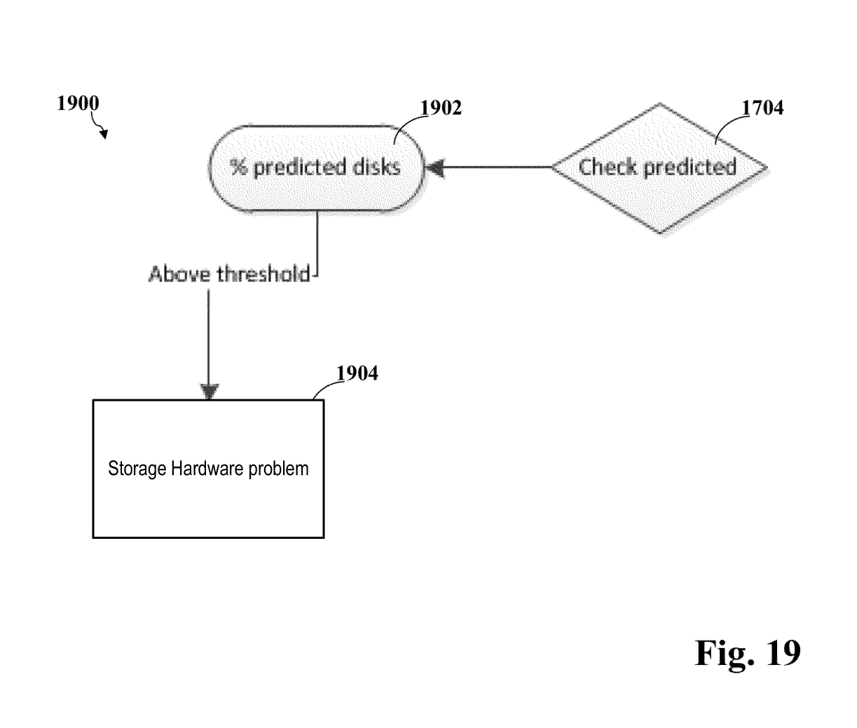

Reference is made to FIG. 19, which schematically illustrates a workflow 1900 for checking if a decrease in storage throughput is caused by a storage disk, in accordance with an embodiment of the invention. Workflow 1900 may include detailed steps of operation 1704 of FIG. 17 to check predicted disk errors.

In operation 1902, the percentage of the predicated disk error may be determined. If the percentage of the predicated disk error is above a predetermined threshold, it may be determined in operation 1904 that storage hardware is the cause of the decrease in storage throughput.

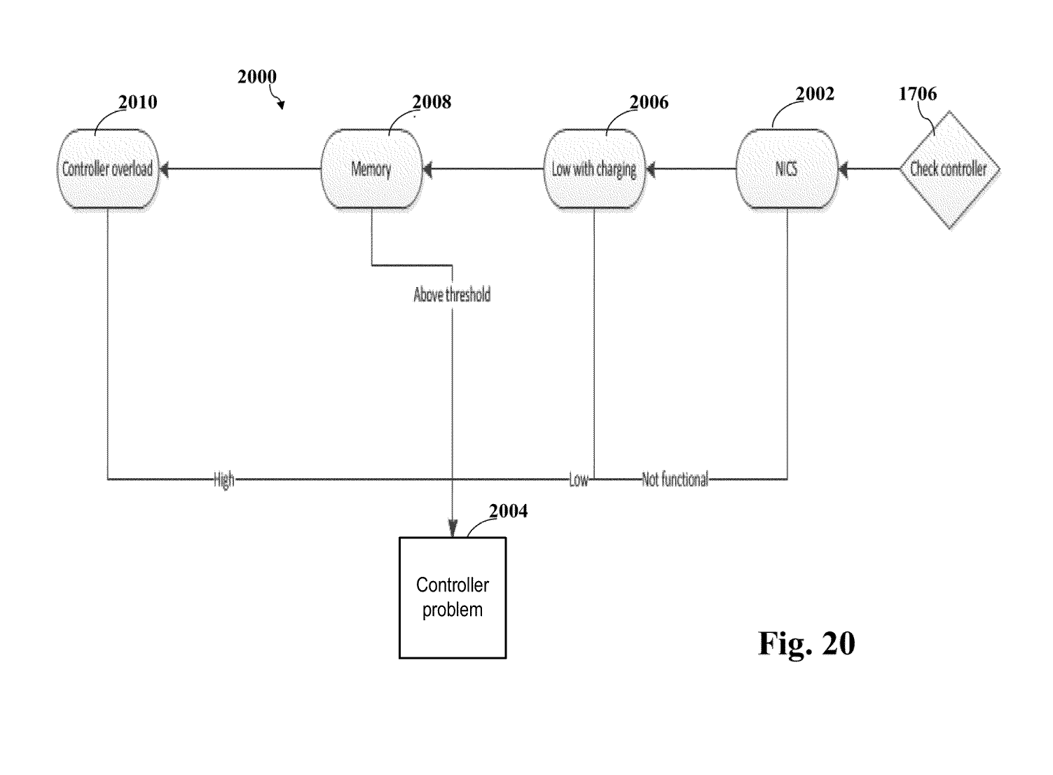

Reference is made to FIG. 20, which schematically illustrates a workflow 2000 for checking if a decrease in storage throughput is caused by a controller, in accordance with an embodiment of the invention. Workflow 2000 may include detailed steps of operation 1706 of FIG. 17 to check the controller.

In operation 2002, the network interface cards may be checked for functionality. If the network interface cards are not functional, it may be determined in operation 2004 that the controller is the cause of the throughput problem. If the network interface cards are functional, the battery may be checked in operation 2006 to determine if the battery has a low charge. If the battery has insufficient charge or energy, it may be determined that the controller is the cause of the throughput problem. If the battery has sufficient charge, the memory status may be checked in operation 2008 to determine if the memory has an above threshold amount of stored data. If so, it may be determined that the controller is the cause of the throughput problem. If the memory has a below threshold amount of stored data, the overloaded of the controller may be checked in operation 2010. If the controller overload is above a threshold, it may be determined that the controller is the cause of the throughput problem. Otherwise, other checks may be used.

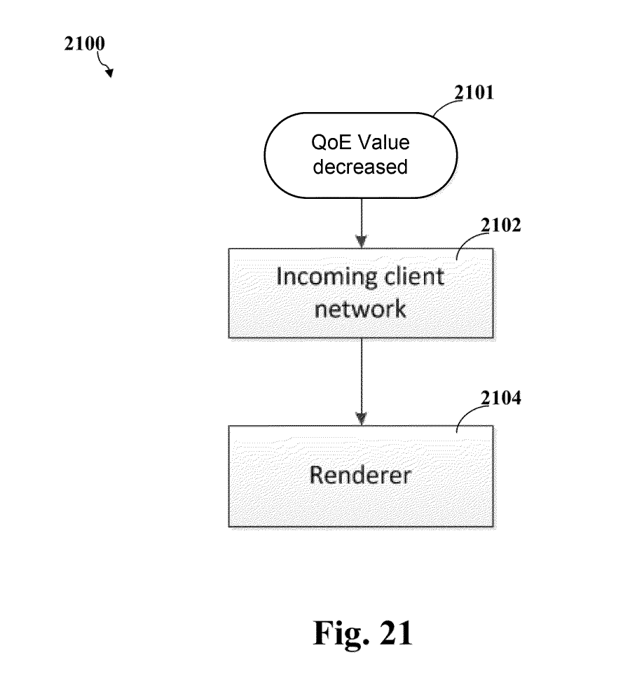

Reference is made to FIG. 21, which schematically illustrates a workflow 2100 for detecting a cause of a decrease in a quality of experience measurement in accordance with an embodiment of the invention. In one example, workflow 2100 may be triggered by detecting a decrease in the QoE measurement in operation 2101, e.g., that falls below a predetermined threshold.

Workflow 2100 may be divided into the following check categories, for example (other categories may also be used):
Incoming client network check 2102 may analyze a combination of performance measures to check the performance associated with the transfer of data between a client (e.g., client 416 of FIG. 4) and a recorder (e.g., edge devices 410 and/or recorder server 412 of FIG. 4).
Renderer check 2104 may analyze a combination of performance measures associated with the performance of the client and specifically, the video renderer (e.g., video renderer 418 of FIG. 4).

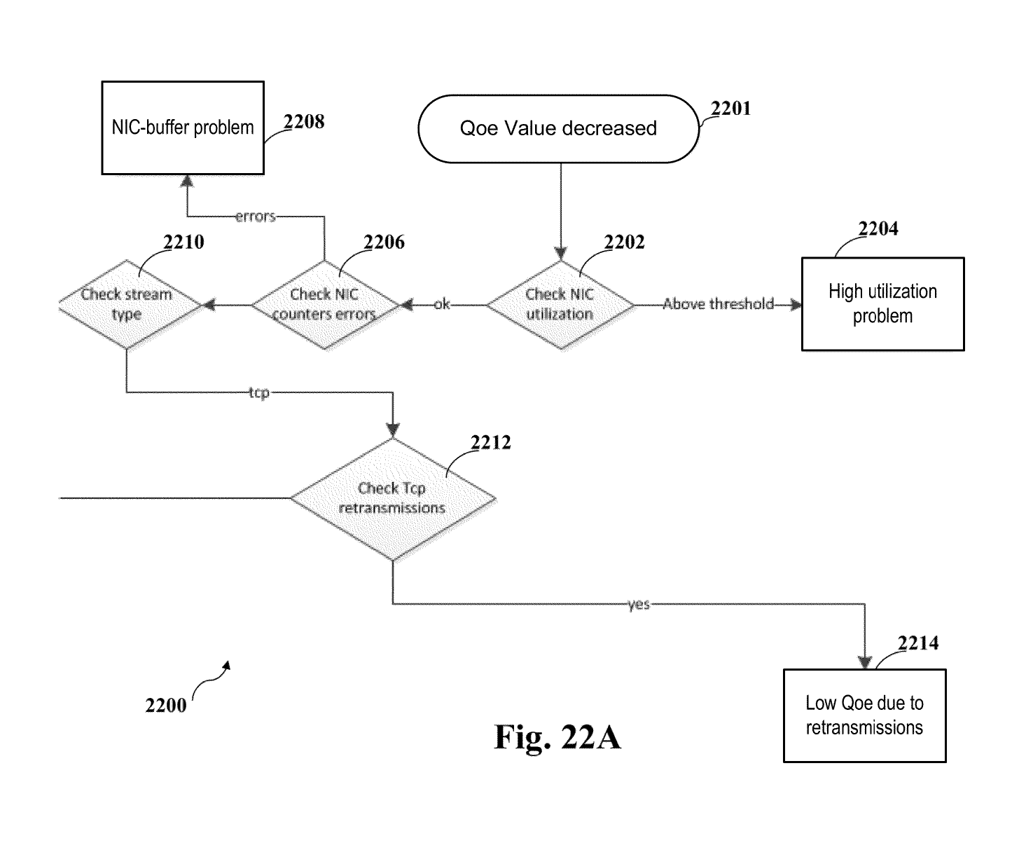

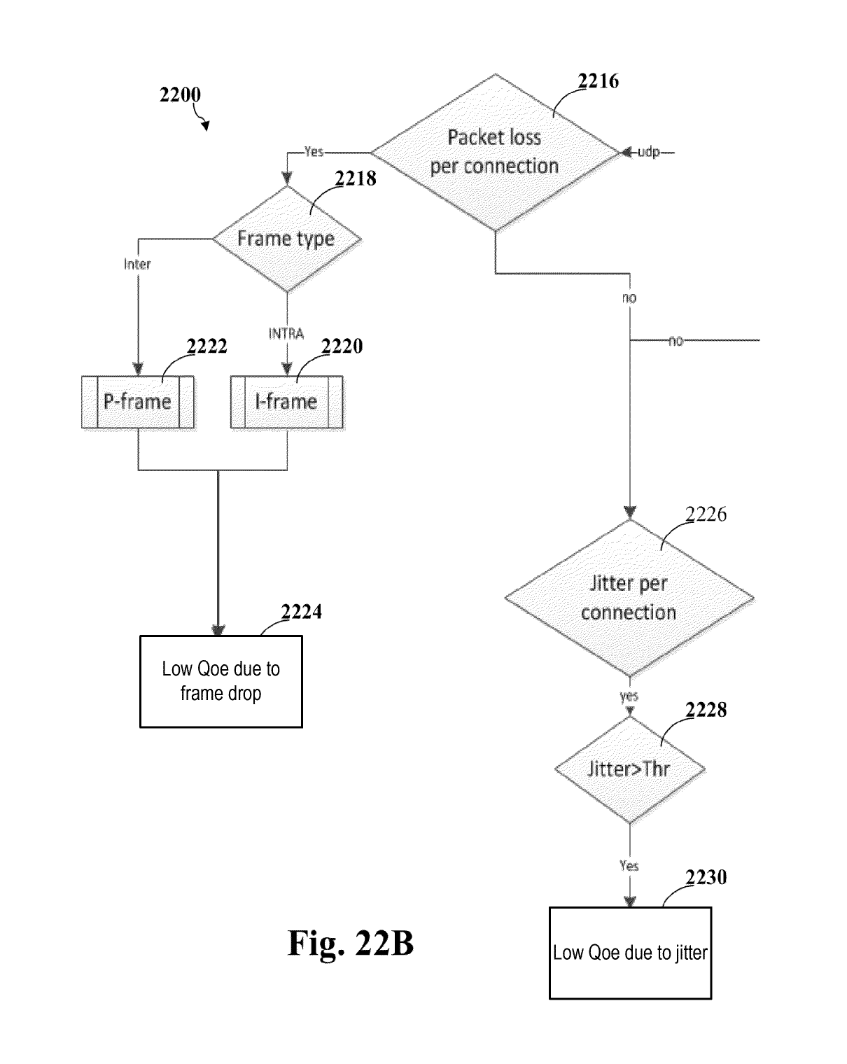

Reference is made to FIGS. 22A and 22B, which schematically illustrate a workflow 2200 for detecting if a cause of a decrease in a quality of experience measurement is a network component in accordance with an embodiment of the invention. Workflow 2200 may determine if, for example, the cause of the decrease QoE measurement is a result of a component of a network (e.g., network 408 of FIG. 4) between a client (e.g., client 416 of FIG. 4) and a recorder (e.g., edge devices 410 and/or recorder server 412 of FIG. 4). FIGS. 22A and 22B are two figures that illustrate a single workflow 2200 separated onto two pages due to size restrictions.

In one example, workflow 2200 may be triggered by detecting a decrease in the QoE measurement in operation 2201, e.g., that falls below a predetermined threshold.

In operation 2202, the utilization of a network interface card may be checked. If an NIC utilization parameter is above a threshold, the NIC may be over-worked causing packets to remain unprocessed and it may be determined in operation 2204 that the cause of the decreased in quality of experience is the over-utilization of the NIC. However, if the NIC utilization parameter is below a threshold, workflow 2200 may proceed to operation 2206 to check for NIC errors. The following performance counters on the NIC may be checked for errors:
Error packet counter, which if above a threshold may indicate that packets arrive malformed.
Discard packet counter, which if above threshold may indicate that the NIC buffer is full and cannot handle incoming packets.
   If errors are detected in any NIC counter in operation 2206, it may be determined in operation 2208 that the cause of the decreased in quality of experience is a problem with the NIC buffer. If no errors are found, workflow may proceed to operation 2210.

In operation 2210, a communication or stream type of the data packet transmissions may be checked. The stream type may be, for example, user datagram protocol (UDP) or transmission control protocol (TCP).

If the stream type is UDP, workflow 2200 may proceed to operation 2200 of FIG. 22B to check if there is packet loss in each connection. If there is packet loss, it may be determined in operation 2218 which frame(s) were lost. If an intra (I)-frame is determined to be lost in operation 2220, this loss may be associated with a greater loss to the QoE measurement than if decrease than a predicted picture (P)-frame is determined to be lost as in operation 2222. If the decrease in the QoE measurement is correlated to the expected decrease due to the lost I, P or any other packets, it may be determined in operation 2224 that the cause of the decreased in the QoE measurement is packet loss.

If the stream type is determined in operation 2210 to be TCP, a level of TCP retransmissions may be checked in operation 2212. If the level is above a predetermined threshold, such retransmissions may cause latency and may be determined in operation 2214 to be the cause of the decreased in quality of experience. If however, the TCP retransmission level is below a predetermined threshold, workflow 2200 may proceed to operation 2226 of FIG. 22B to check for jitter in the video data stream. If a jitter parameter measured in operation 2228 is above a threshold, it may be determined in operation 2230 that the cause of the decreased in quality of experience is jitter.

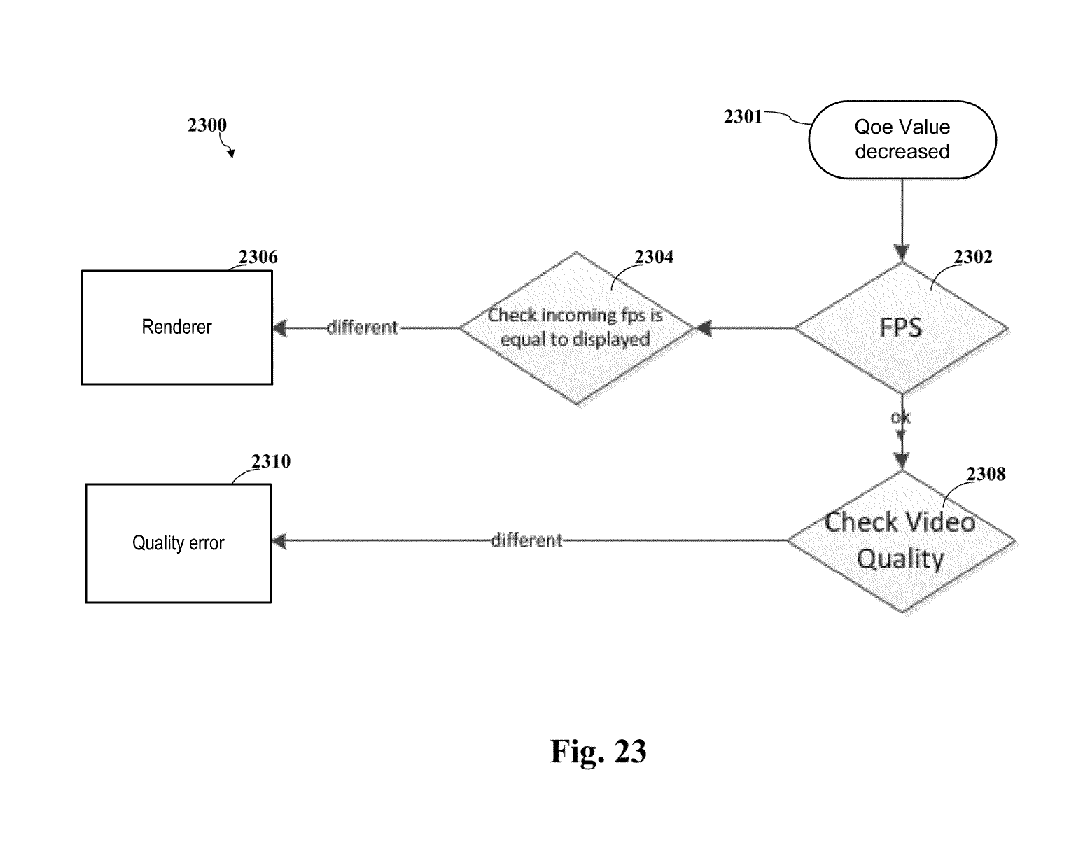

Reference is made to FIG. 23, which schematically illustrates a workflow 2300 for detecting if a cause of a decrease in a quality of experience measurement is a client component in accordance with an embodiment of the invention. In one example, workflow 2300 may be triggered by detecting a decrease in the QoE measurement in operation 2301, e.g., that falls below a predetermined threshold.

In operation 2302, the incoming frame rate (e.g., framer per second (FPS)) of a video stream may be measured and compared in operation 2304 to the output frame rate, e.g., displayed at a client computer. If the frame rates are different, it may be determined in operation 2306 that the cause of the decreased in quality of experience is a video renderer (e.g., video renderer 418 of FIG. 4). However, if the frame rates are equal, workflow 2300 may proceed to operation 2308 to check the quality of the frames of the video stream. If the quality of the frames is different than excepted, e.g., as defined by a quantization value or compression score, it may be determined in operation 2310 that the cause of the decreased in the QoE measurement is poor video quality.

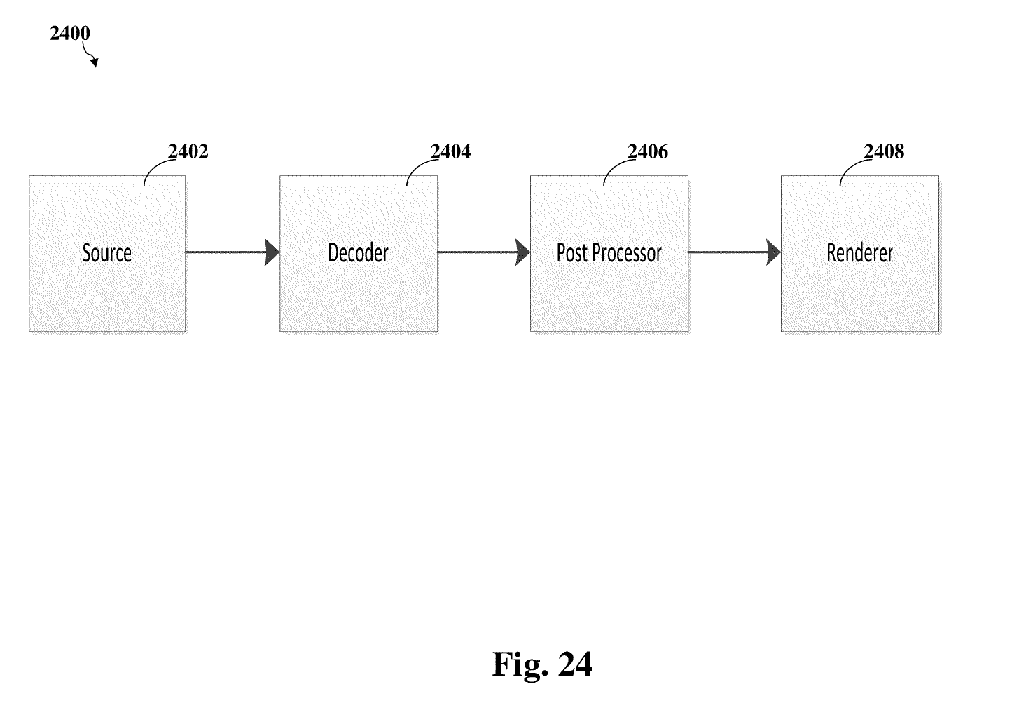

Reference is made to FIG. 24, which schematically illustrates a system 2400 for transferring of data from a source device to an output device in accordance with an embodiment of the invention.

Data may be transferred in the system (e.g., system 100 of FIG. 1) from a source 2402 to a decoder 2404 to a post-processor 2406 to a renderer 2408. Source 2402 may provide and/or collect the source data and may, for example, be a recorder (e.g., recorder 110 of FIG. 1), an edge device (e.g., edge device 111 of FIG. 1) or an intermediate device, such as a storage unit (e.g., storage unit 112 or CSS 130 of FIG. 1). Decoder 2404 may decode or uncompress the received source data, e.g., to generate raw data, and may, for example, be a decoding device or software unit in a client workstation (e.g., user devices 122, 124 or 126 of FIG. 1). Post-processor 2406 may process, analyze or filter the decoded data and may, for example, be a processing device or software unit (e.g., of AMS 116 of FIG. 1). Renderer 2408 may display the data on a screen of an output device and may, for example, be a video renderer (e.g., video renderer 418 of FIG. 4). Renderer 2408 may drop frames causing the incoming frame rate to be different (e.g., smaller) than the outgoing or display frame rate. The output device may be, for example, a client or user device (e.g., user devices 122, 124 or 126 of FIG. 1 or client 416 of FIG. 4) or managerial or administrator device (e.g., AMS 116 of FIG. 1).

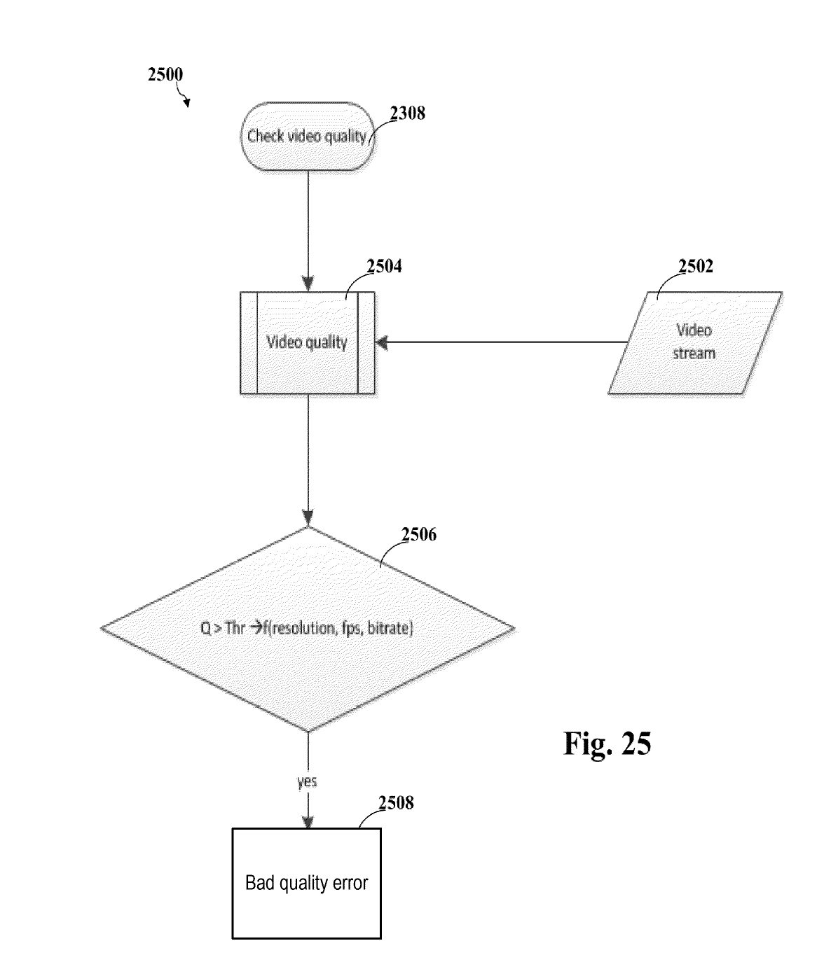

Reference is made to FIG. 25, which schematically illustrates a workflow 2500 for checking if a decrease in a quality of experience measurement is caused by low video quality, in accordance with an embodiment of the invention. Workflow 2500 may include detailed steps of operation 2308 of FIG. 23 to check video quality.

In operation 2502, a video stream may be received, for example, from a video source (e.g., recorder 110 or edge device 111 of FIG. 1).

In operation 2504, an average quantization value, Q, may be computed for I-frames of the received video stream and may be mapped to a compression video quality score (e.g., according to the relationship defined in table 15).

In operation 2506, the average quantization value, Q, or compression video quality score may be compared to a threshold range, which may be a function of a resolution, frame rate and bit-rate of the received video stream. In one example, the quantization value, Q, may range from 1 to 51, and may be divided into four score categories as follows (other value ranges and corresponding scores may be used):

Q<20=excellent

20<Q<30=very good

30<Q<40=good/normal

Q>40=potential video quality problem

If the quantization value or score is within the threshold range, the video quality may be determined in operation 2508 to be lower than desired and the video quality may be determined to be the cause of the decrease in the quality of experience measurement.

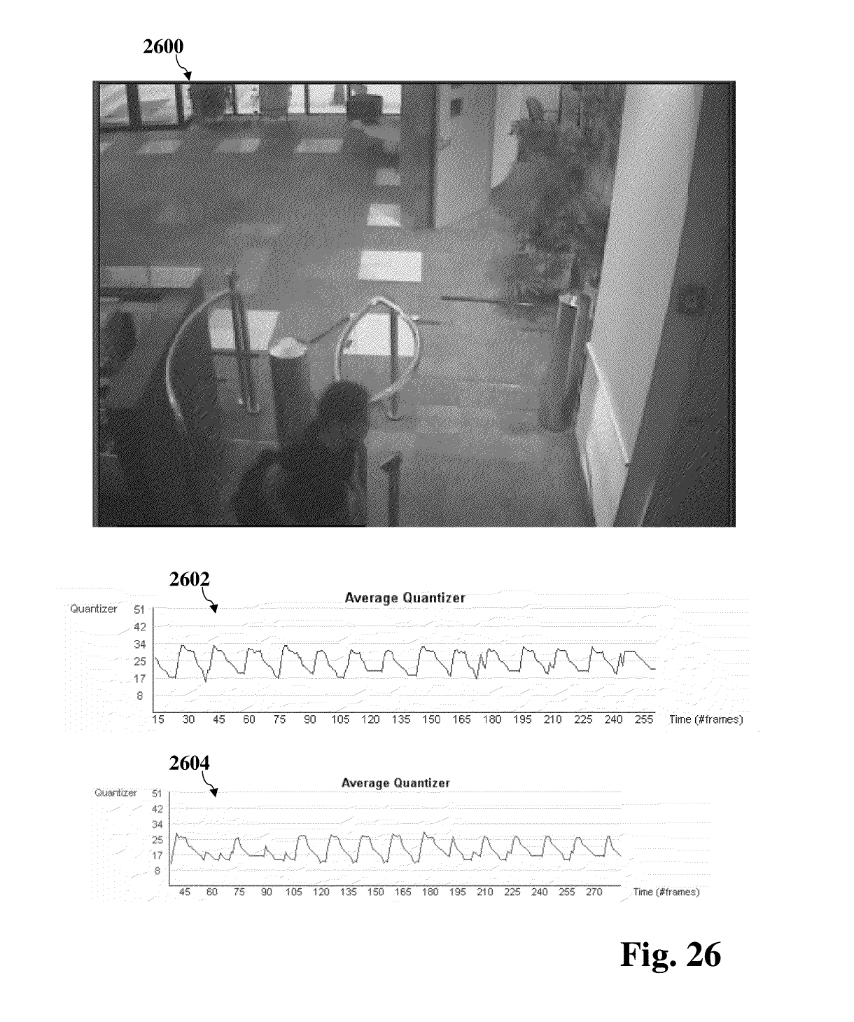

Reference is made to FIGS. 26, 27 and 28, each of which include an image from a separate video stream and graphs of the average quantization value, Q, of the video streams, in accordance with an embodiment of the invention. Graphs 2602 and 2604 represent the average quantization values, Q, with respect to time (or frame number) of a first image stream including image 2600, graphs 2702 and 2704 represent the average quantization values, Q, with respect to time (or frame number) of a second image stream including image 2700 and graphs 2802 and 2804 represent the average quantization values, Q, with respect to time (or frame number) of a third image stream including image 2800. The graphs in each pair of graphs 2602 and 2604, 2702 and 2704, and 2802 and 2804, represent the average quantization values for the same image at different bit-rates. Other data and other graphs may be used.

In FIG. 26, the first video stream, including image 2600, may have a common intermediate format (CIF) resolution (e.g., 352×240 pixel-by-pixel frames) and a real-time frame rate (e.g., 30 frames per second (fps)). Graph 2602 uses an approximately optimal bit-rate for this scene (e.g., 768 kilobytes per second (Kbps)), while graph 2604 uses a less optimal bit-rate for this scene (e.g., 384 Kbps).

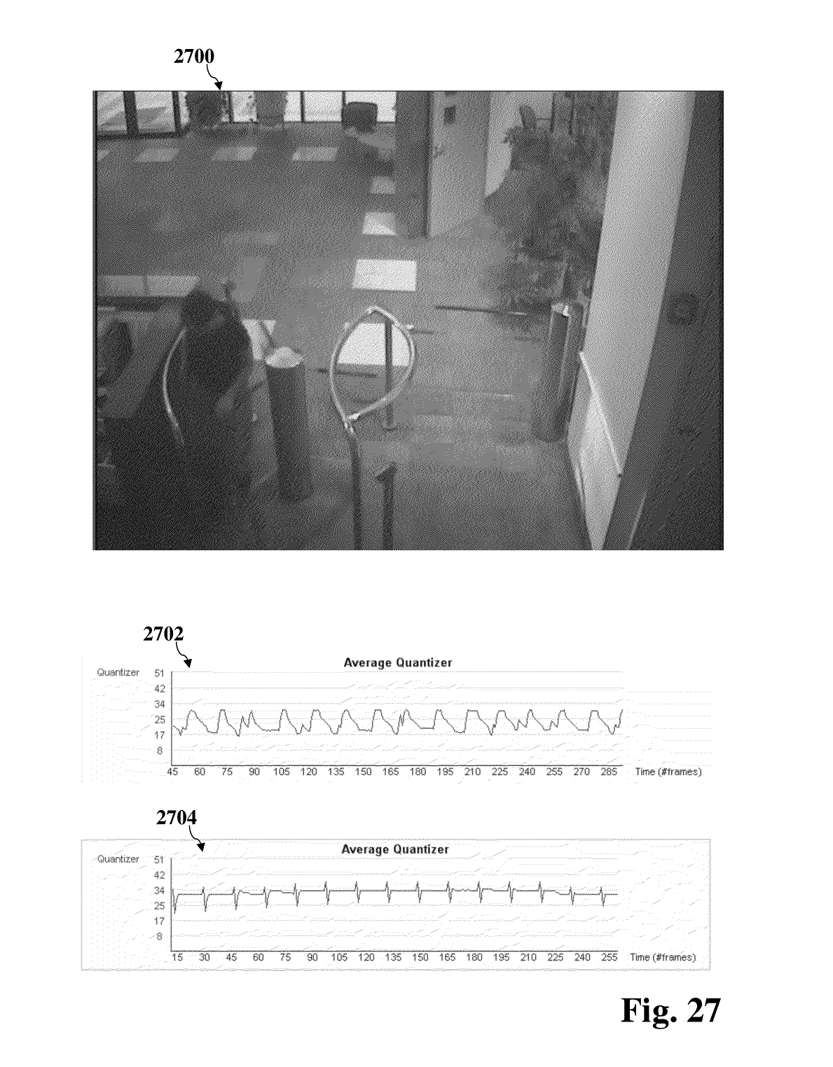

In FIG. 27, the second video stream, including image 2700, may have a 4 CIF resolution and a real-time frame rate. Graph 2702 uses an approximately optimal bit-rate for this scene (e.g., 1536 Kbps), while graph 2704 uses a less optimal bit-rate for this scene (e.g., 768 Kbps).

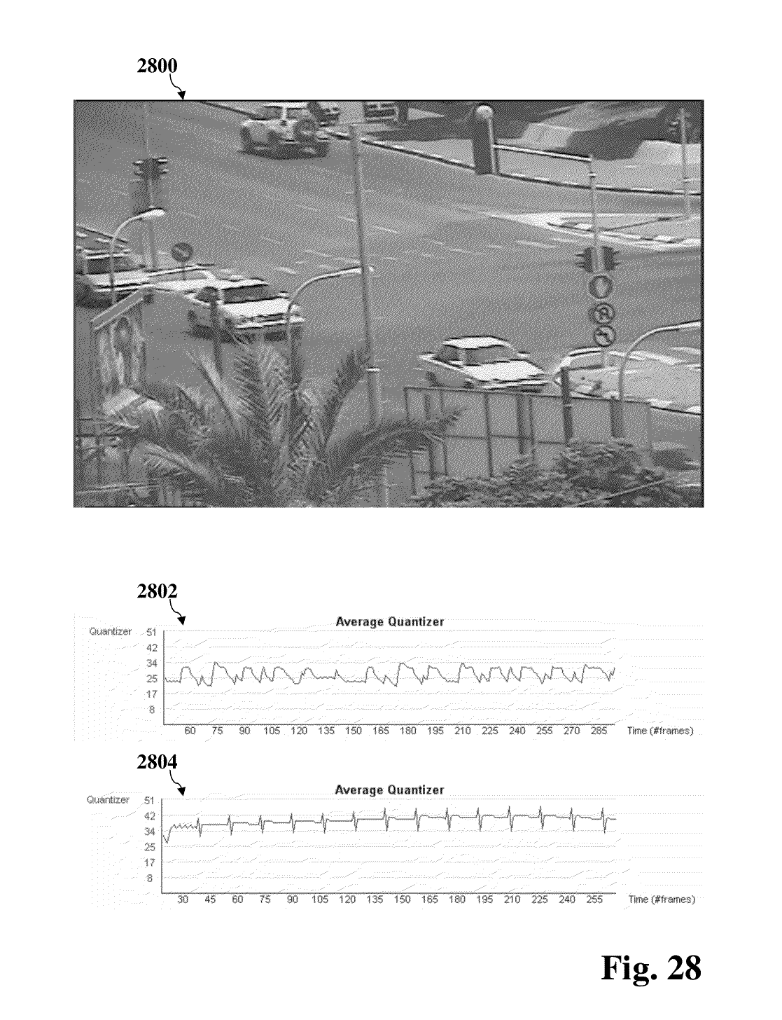

In FIG. 28, the third video stream, including image 2800, may have a 4 CIF resolution and a real-time frame rate. Graph 2802 uses an approximately optimal bit-rate for this scene (e.g., 2048 Kbps), while graph 2704 uses a less optimal bit-rate for this scene (e.g., 768 Kbps).

In FIGS. 26, 27 and 28, the difference in quality of a video stream processed or transferred at optimal and sub-optimal bit-rates may be detected by comparing their respective average quantization graphs 2602 and 2604, 2702 and 2704, and 2802 and 2804.

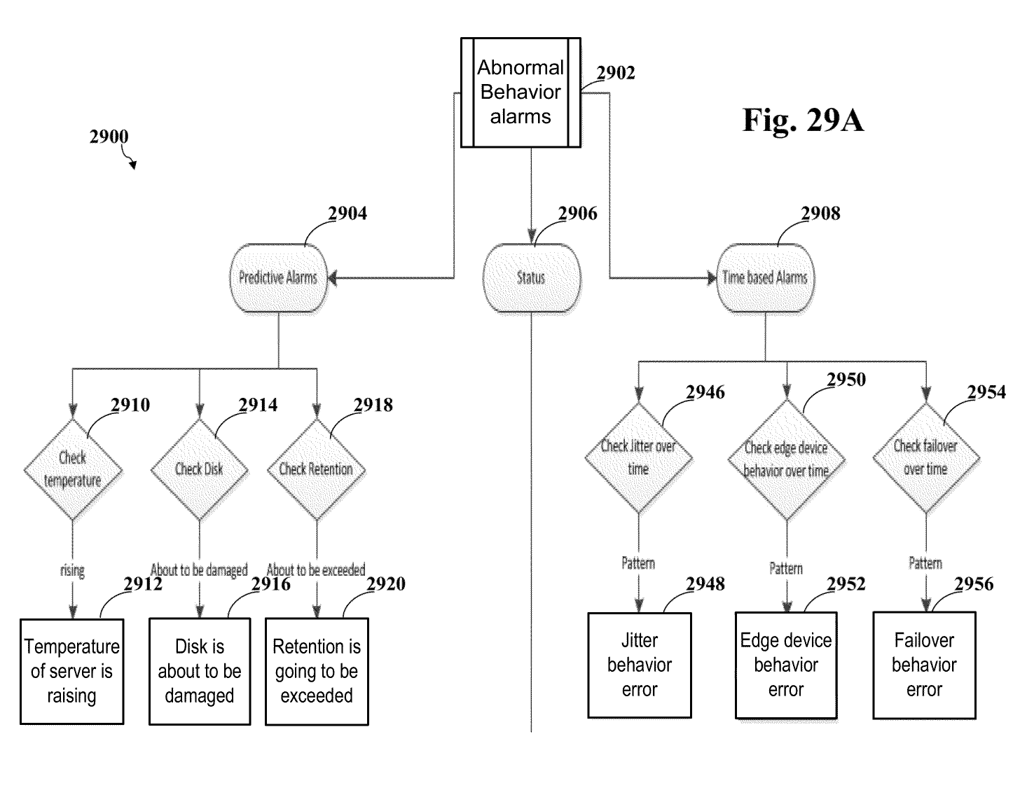

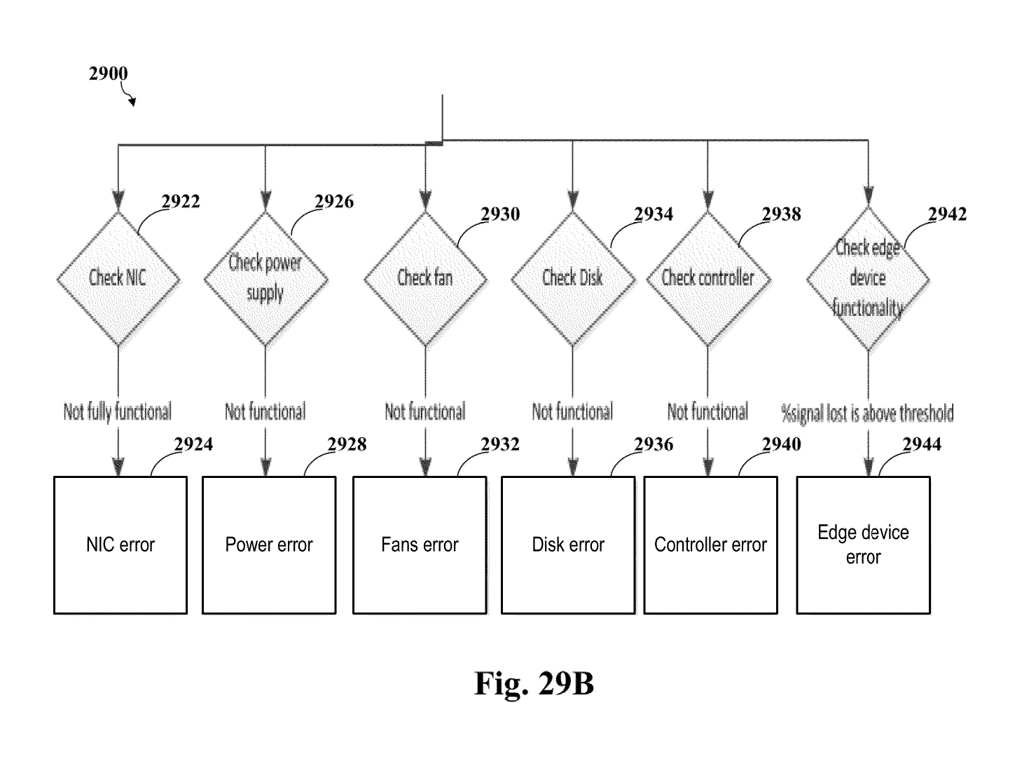

Reference is made to FIGS. 29A and 29B, which schematically illustrate a workflow 2900 for using abnormal behavior alarms in accordance with an embodiment of the invention. FIGS. 29A and 29B are two figures that illustrate a single workflow 2900 separated onto two pages due to size restrictions.

In operation 2902, abnormal behavior alarms (e.g., alarms 626 of FIGS. 6 and 900 of FIG. 9) may be tested. Testing the alarms may be triggered automatically or upon satisfying predetermined criteria, such as, a management device (e.g., AMS 116 of FIG. 1) detecting abnormal behavior when monitoring performance statistics of system components. The performance statistics may include, for example, recorded or storage throughput values, quality of experience values, and/or patterns thereof over time or frame number.

One or more of the following abnormal behavior alarms may be used, for example (other alarms may also be used):
Predictive alarms used in operation 2904 may notify a client or user (e.g., at a management interface) of predicted future changes in operation or performance of system components, including decrease in performance, increase in performance, failure of components or complete system shut-down. Predictive alarms may include the following tests for example (other tests may also be used):
   A temperature test may check in operation 2910 if the temperature crossed the upper bound of an optimal (or any) predetermined temperature threshold or range. If so, a predictive alarm may alert the user in operation 2912 that the temperature is rising and/or may be accompanied by a corresponding of predicted outcomes, such as, device failure, and/or suggested solution, such as, to cool the affected unit(s) with a fan or turn the unit(s) off. In another embodiment, the management device may automatically activate the fan or put the unit(s) to sleep and/or re-allocate their tasks to other units, e.g., by load balancing.
   A disk test may check in operation 2914 if one or more operational disks are expected to become damaged. If so, a predictive alarm may alert the user in operation 2916 that a disk may be damaged and/or the address of the disk in storage.
   A retention test may check in operation 2918 if retention is expected to exceed a predetermined threshold or range. If so, a predictive alarm may alert the user in operation 2920 that retention may be exceeded.
Status alarms used in operation 2906 may notify the client or user of the current operation or performance of system components. Status alarms may include the following tests for example (other tests may also be used):
   A NIC test may check in operation 2922 if the NIC has errors. If so, a status alarm may alert the user in operation 2924 that NIC has errors.
   A power supply test may check in operation 2926 has a below threshold amount of power. If so, a status alarm may alert the user in operation 2928 of a power error.
   A fan test may check in operation 2930 if one or more fans are operational. If so, a status alarm may alert the user in operation 2932 of a fan error.
   A disk test may check in operation 2934 if one or more disks in a storage structure are damaged. If so, a status alarm may alert the user in operation 2936 of a disk error.
   A controller test may check in operation 2938 if a controller is not operational. If so, a status alarm may alert the user in operation 2940 of a controller error.
   An edge device test may check in operation 2942 if a percentage of signal lost is above a predetermined threshold for one or more edge devices. If so, a status alarm may alert the user in operation 2944 of an edge device error.
Time based alarm used in operation 2908 may check for patterns of behavior in the data that occur over time or across multiple frames.
   A jitter behavior test may check in operation 2946 for the presence of jitter recorded over time. If jitter is detected, a time based alarm may alert the user in operation 2948 of a jitter behavior error.
   An edge device behavior test may check in operation 2950 for a pattern of sub-optimal behavior of one or more edge devices over time. If the pattern of poor edge device behavior is detected, a time based alarm may alert the user in operation 2952 of an edge device behavior error.
   A failover behavior test may check in operation 2954 for the presence of failover over time, e.g., an automatic switching from one device or process to another (teamed) device or process typically after the failure or malfunction of the first. The presence of failover recorded over time may cause an alarm to alert the user in operation 2956 of a failover behavior error.

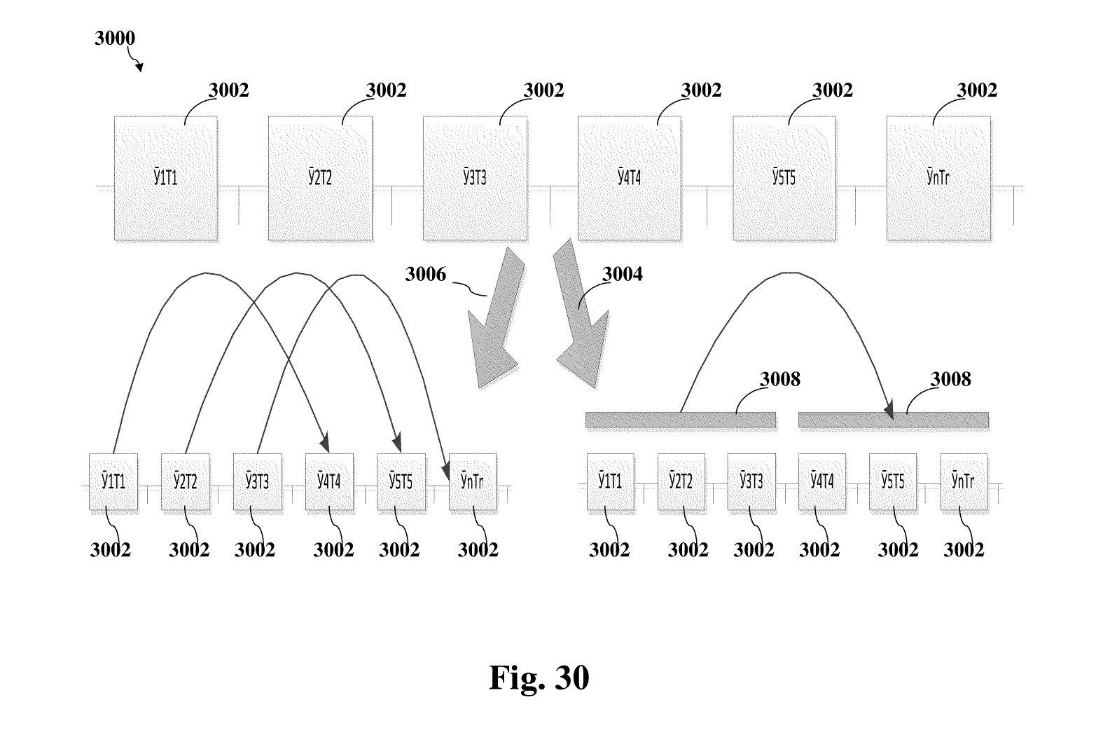

Reference is made to FIG. 30, which schematically illustrates a system of data structures 3000 used to detect patterns of behavior over time in accordance with an embodiment of the invention. The behavior may be fluctuations in throughput, viewing experience, video quality or any other performance based statistics.

Data structures 3000 may include a plurality of data bins 3002 (e.g., bins 202 of FIG. 2) storing statistical data collected over time. Each data bin 3002 (i=1, . . . , n) may represent the statistical data Y̅i (i=1, . . . , n) collected over a time range Ti (i=1, . . . , n) and averaged, for example, to be Y̅i Ti. After processing (n) bins 3002, bins 3002 may be tested for patterns in different modes, for example, in a group mode in operation 3004 to detect patterns between groups of bins 3002 and/or in an individual or single time slot mode in operation 3006 to detect patterns between individual bins 3002.

To test for patterns between groups of bins 3002 in group mode in operation 3004, adjacent bins 3002 may be averaged and combined into groups 3008 and adjacent groups may be compared, for example, using a Z-test to detect differences between groups. For example, a group 3008 of day-time bins may be compared to a group 3008 of night-time bins, a group 3008 of week-day bins may be compared to a group 3008 of week-end bins, etc., to detect patterns between groups 3008 at such periodicity or times.

To test for patterns between individual bins 3002 in single time slot mode in operation 3006, individual bins 3002 may be compared, e.g., bin Y̅1 T1 may be compared to bin Y̅4T4, to bin Y̅7T7, etc., for example, using a Z-test. Individual bins 3002 with values that differ from a total average may be identified and it may be determined if those bins 3002 occurs repeatedly at constant time intervals, such as, every (j) bins 3002.

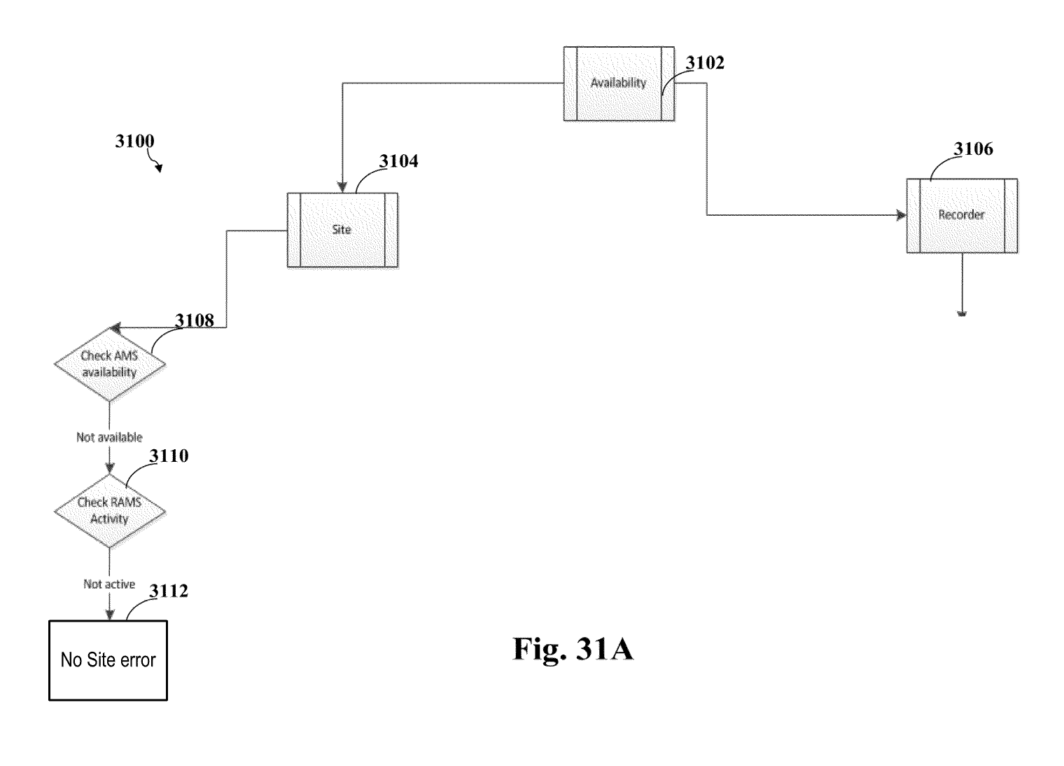

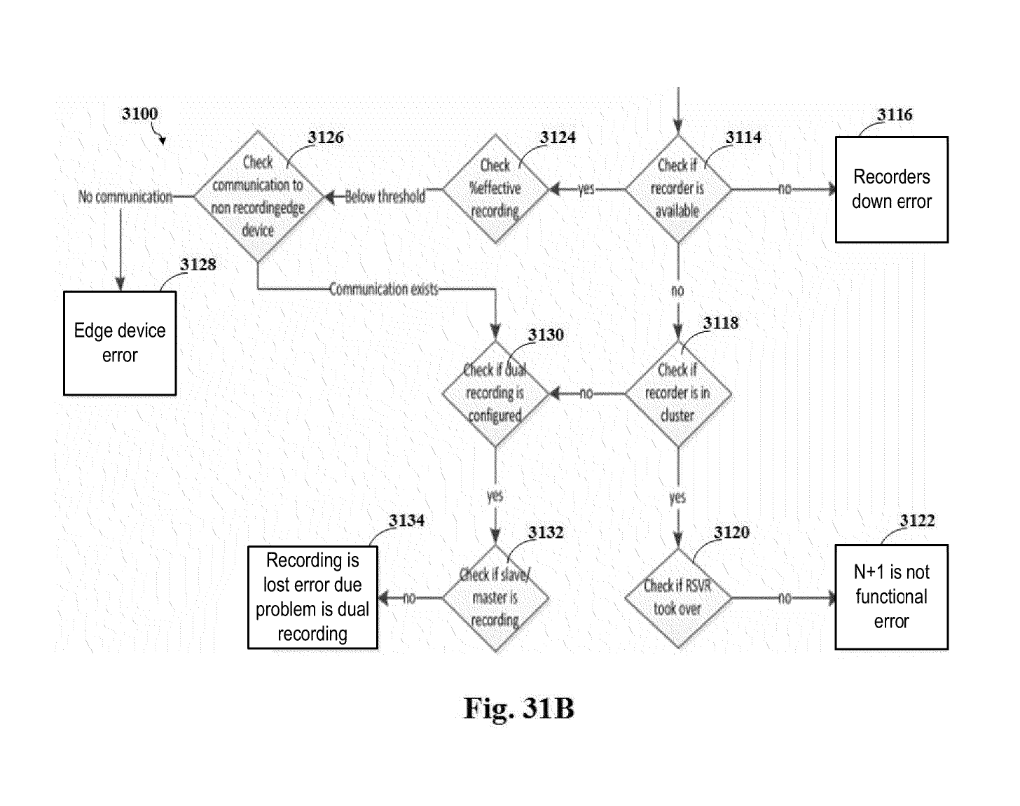

Reference is made to FIGS. 31A and 31B, which schematically illustrate a workflow 3100 for determining availability insights/diagnoses in accordance with an embodiment of the invention. FIGS. 31A and 31B are two figures that illustrate a single workflow 3100 separated onto two pages due to size restrictions.

In the example shown in FIGS. 31A and 31B, computing an availability score 3102 (e.g., availability 624 of FIG. 6) includes measuring the availability of a management server (e.g., AMS 116 of FIG. 1) in operation 3104 and/or a recorder (e.g., recorder 110 of FIG. 1) in operation 3106, although other availability scores may be used, such as, storage connection availability score (e.g., defined in table 8), storage read availability score (e.g., defined in table 9), etc.

To determine the management server availability, in operation 3108, a management device (e.g., AMS 116 of FIG. 1) may be checked to determine if it is available (online) or unavailable (offline) and, in operation 3110, a redundant management server (RAMS) may be checked to determine if it is available or unavailable. If both the management device and RAMS are unavailable, it may be determined in operation 3112 that there is no management server error.

To determine the recorder availability, in operation 3114, the recorder may be checked to determine if it is available. If the recorder is unavailable, it may be determined in operation 3116 that there is a recorder error and the recorder may be checked in operation 3118 to determine it the recorder is configured in a cluster. If not, workflow 3100 may proceed to operation 3130. If so, a redundant recorder in the cluster, such as, a redundant network video recorder (RNVR), may be checked in operation 3120 for availability. If any problems are detected during the checks in operation 3120, it may be determined in operation 3122 that the redundant recorder is not available.

However, if it is determined in operation 3114 that the recorder is available, the percentage of effective recording channels may be checked in operation 3124 and compared to a configure value. If that percentage is lower than a threshold, the edge device may be evaluated in operation 3126 for communication problems. If communication problems are detected with the edge device (e.g., poor or no communication), it may be determined in operation 3112 that there is an edge device error. However, if no communication problems are detected with the edge device, internal problems with the recorder may be checked in operation 3130, such as, dual recording configuration settings. If the dual recording settings are configured correctly, it may be determined in operation 3130 if a slave or master recorder is recording. If not, it may be determined in operation 3134 that a recording is lost and there is a dual recording error.

Workflows 300, 1000-2500, 2900 and 3100, of FIGS. 3, 10-25, 29A, 29B, 31A and 31B may be executed by one or more processors or controllers, for example, in a management device (e.g., processor 140 of AMS 116 or an application server 120 processor in FIG. 1), an administrator, client or user device (e.g., user devices 122, 124 or 126 of FIG. 1), at a collection segment (e.g., by processor 110 of recorder 114 or an edge device 111 processors), at a storage server processor (e.g., processor 148 of CSS 130), etc. Workflows 300, 1000-2500, 2900 and 3100 may include other operations or orders of operations. Although embodiments of workflows 300, 1000-2500, 2900 and 3100 are described to execute VSM operations to monitor system performance, these workflows may be equivalently used for any other system management purpose, such as, managing network security, scheduling tasks or staff, routing customer calls in a call center, automated billing, etc.

It may be appreciated that “real-time” or “live” operations such as playback or streaming may refer to operations that occur instantly, at a small time delay of, for example, between 0.01 and 10 seconds, during the operation or operation session, concurrently, or substantially at the same time as.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for virtual system management comprising:
analyzing a set of data received from a plurality of data sensors each monitoring performance at a different system component;
identifying sub-optimal performance associated with at least one component based on data analyzed for that component's sensor;
determining the cause of the sub-optimal performance using predefined relationships between different value combinations including scores for the set of received data and a plurality of causes; and
sending an indication of the determined cause.

2. The method of claim 1 comprising determining a solution to improve the sub-optimal performance using predefined relationships between the plurality of causes of problems and a plurality of solutions to correct the problems.

3. The method of claim 2 comprising executing the determined solution by automatically altering the behavior of the component associated with the sub-optimal performance.

4. The method of claim 1, wherein analyzing the set of received data comprises computing a performance function to weigh the effect of data sensed for each component on the overall system performance.

5. The method of claim 4, wherein data sensed for each component is weighed according to the probability for problems to occur at the component.

6. The method of claim 1, wherein analyzing the set of received data measures throughput.

7. The method of claim 1, wherein analyzing the set of received data measures quality of experience (QoE).

8. The method of claim 1, wherein analyzing the set of received data identifies patterns of change in the performance of components monitored over time.

9. The method of claim 1, wherein the sub-optimal component performance is identified to occur in the future.

10. The method of claim 1, wherein the set of data received from the sensors monitors performance parameters selected from the group consisting of: packet loss, jitter, bit rate, frame rate and simple network management protocol (SNMP) entries.

11. A system for virtual system management comprising:
a memory; and
a processor to analyze a set of data received from a plurality of data sensors each data sensor monitoring performance at a different system component, to identify sub-optimal performance associated with at least one component based on data analyzed for that component's sensor, to determine the cause of the sub-optimal performance using predefined relationships between different value combinations including scores for the set of received data and a plurality of causes.

12. The system of claim 11, wherein the processor is to determine a solution to improve the sub-optimal performance using predefined relationships between the plurality of causes of problems and a plurality of solutions to correct the problems.

13. The system of claim 12, wherein the processor is to execute the determined solution by automatically triggering a change in the behavior of the component associated with the sub-optimal performance.

14. The system of claim 11, wherein the processor is to analyze the set of received data by computing a performance function to weigh the effect of data sensed for each component on the overall system performance.

15. The system of claim 14, wherein the processor is to weigh the data sensed for each component according to the probability for problems to occur at the component.

16. The system of claim 11, wherein the processor is to analyze the set of received data by measuring throughput.

17. The system of claim 11, wherein the processor is to analyze the set of received data by measuring quality of experience (QoE).

18. The system of claim 11, wherein the processor is to analyze the set of received data by identifying patterns of change in the performance of components monitored over time.

19. The system of claim 11, wherein the processor is to predict that the sub-optimal component performance occurs in the future.

20. The system of claim 11, wherein the plurality of data sensors monitor performance parameters selected from the group consisting of: packet loss, jitter, bit rate, frame rate and simple network management protocol (SNMP) entries.
